(19) United States
(12) Patent Application Publication
(10) Pub. No.: US 2026/0132681 A1
(43) Pub. Date: May 14, 2026

(54) LADDER FOOTPAD AND LADDER FOOT ASSEMBLIES AND LADDERS THEREWITH

(71) Applicant: Werner Co., Itasca, IL (US)

(72) Inventors: Slavisa Dacic, Hanover Park, IL (US); Juan Carlos Perez, Huntersville, NC (US); David S. Pozgay, Wilmette, IL (US); Aditya Singh, Chicago, IL (US)

(21) Appl. No.: 19/381,927

(22) Filed: Nov. 6, 2025

Related U.S. Application Data
(60) Provisional application No. 63/101,188, filed on Nov. 11, 2024.
(60) Provisional application No. 63/719,003, filed on Nov. 11, 2024.

(51) Int. Cl. E06C 7/46; E06C 1/20

(52) U.S. Cl. CPC E06C 7/46; E06C 1/20

(57) ABSTRACT

A footpad for a ladder, provided herein, includes a top side and a bottom side, the bottom side defining treading, and a front side, a rear side, an inner side, and an outer side. The bottom side of the footpad is curved, defining a first curvature from the inner side to the outer side and a second curvature from the front side to the rear side. Another footpad for a ladder provided herein includes a lip extending upwardly to engage a cover component of a ladder foot. Ladder foot assemblies and ladders with the footpads are also provided.

### CROSS-REFERENCE TO RELATED APPLICATIONS

This application claims the benefit of U.S. Provisional Application No. 63/101,188 filed Nov. 11, 2024 and U.S. Provisional Application No. 63/719,003 filed Nov. 11, 2024, the contents of which are incorporated by reference herein in their entireties.

### TECHNICAL FIELD

This disclosure relates to ladder feet, and, in particular, to ladder feet with footpads.

### BACKGROUND

Conventional ladders often face stability issues because they support heavy loads on a relatively narrow base. The narrow base can make the ladder vulnerable to tipping or wobbling when weight shifts or when subjected to lateral forces.

In addition, conventional ladders are commonly equipped with simple or flat feet or footpads to stabilize the ladder against a flat surface. However, these designs often fail to provide adequate stability on uneven, sloped, or irregular terrain, which can lead to excessive wobbling of the ladder during use, posing risks to the user or reducing the user's perception of safety.

To improve stability at the base of a ladder, some ladders have been designed with outriggers, stabilizing bars, or adjustable feet. For instance, some ladder feet have been designed to include responsive or articulating surfaces that can be adjusted depending on the type of ground surface or to include rubber grips. However, these approaches often require complex mechanisms, additional parts, or cumbersome attachments that can be difficult to deploy, add significant weight and/or cost, or restrict the ladder's versatility.

### BRIEF DESCRIPTION OF THE DRAWINGS

FIG. 1 is a front-side perspective view of a ladder according to various embodiments.

FIG. 2 is an enlarged view of a portion of the ladder of FIG. 1 showing a foot assembly thereof according to various embodiments.

FIG. 3 is a partial rear-side perspective view of the foot assembly of FIG. 2.

FIG. 4 is a partial front-side perspective view of the foot assembly of FIG. 2.

FIG. 5 is an exploded view of the foot assembly of FIG. 2.

FIG. 6 is a partial bottom-side perspective view of a brace of the foot assembly of FIG. 2.

FIG. 7 is a top-side perspective view of a footpad of the foot assembly of FIG. 2.

FIG. 8 is a bottom-side view of the footpad of FIG. 6.

FIG. 9 is a bottom-side perspective view of the footpad of FIG. 6.

FIG. 10 is a front-side elevation view of the footpad of FIG. 6.

FIG. 11 is a rear-side elevation view of the footpad of FIG. 6.

FIG. 12 is an outer-side elevation view of the footpad of FIG. 6.

FIG. 13 is an inner-sider elevation view of the footpad of FIG. 6.

FIG. 14 is a front-side perspective view of the footpad of FIG. 6.

FIG. 15 is an outer-side perspective view of the footpad of FIG. 6.

FIG. 16 is a cross-sectional view of the footpad of FIG. 6 taken along line 16-16 of FIG. 9.

FIG. 17 is a cross-sectional view of the footpad of FIG. 6 taken along line 17-17 of FIG. 9.

FIG. 18 is an enlarged partial bottom perspective view of the foot assembly of FIG. 2.

FIG. 19 is an enlarged partial front view of another foot assembly according to various embodiments.

FIG. 20 is an enlarged partial rear view of the foot assembly of FIG. 19.

FIG. 21 is an exploded view of the foot assembly of FIG. 19.

FIG. 22 is a partial bottom-side perspective view of a brace of the foot assembly of FIG. 19.

FIG. 23 is a top-side perspective view of a footpad of the foot assembly of FIG. 19.

FIG. 24 is a top-side plan view of the footpad of FIG. 23.

FIG. 25 is a bottom-side plan view of the footpad of FIG. 23.

FIG. 26 is an outer-side, bottom perspective view of the footpad of FIG. 23.

FIG. 27 is a front-side perspective view of the footpad of FIG. 23.

FIG. 28 is a front-side elevation view of the footpad of FIG. 23.

FIG. 29 is a rear-side elevation view of the footpad of FIG. 23.

FIG. 30A is an outer-side elevation view of the footpad of FIG. 23.

FIG. 30B is an inner-side elevation view of the footpad of FIG. 23.

FIG. 31 is a front-side perspective view of a ladder according to various embodiments.

FIG. 32 is an enlarged view of the ladder of FIG. 31 showing a foot assembly thereof according to various embodiments.

FIG. 33 is a partial front-side perspective view of the foot assembly of FIG. 32.

FIG. 34 is a partial rear-side perspective view of the foot assembly of FIG. 32.

FIG. 35 is an exploded view of the foot assembly of FIG. 32.

FIG. 36 is a partial front-side perspective view of a brace of the foot assembly of FIG. 32.

FIG. 37 is an inner-side, bottom perspective view of the foot assembly of FIG. 32 with a footpad removed.

FIG. 38 is an outer-side, bottom perspective view of the foot assembly of FIG. 32 with a footpad removed.

FIG. 39 is a front-side, top perspective view of a footpad of the foot assembly of FIG. 32.

FIG. 40 is an outer-side, bottom perspective view of the footpad of FIG. 39.

FIG. 41 is a top plan view of the footpad of FIG. 39.

FIG. 42 is a bottom plan view of the footpad of FIG. 39.

FIG. 43 is a front-side elevation view of the footpad of FIG. 39.

FIG. 44 is a rear-side elevation view of the footpad of FIG. 39.

FIG. 45 is an inner-side elevation view of the footpad of FIG. 39.

FIG. 46 is an outer-side elevation view of the footpad of FIG. 39.

FIG. 47 is an inner-side perspective view of a foot cover of the foot assembly of FIG. 32.

FIG. 48 is a front-side, outer-side perspective view of the foot cover of FIG. 47.

FIG. 49 is an outer-side elevation view of the foot cover of FIG. 47.

FIG. 50 is a rear-side, outer-side perspective view of the foot cover of FIG. 47.

FIG. 51 is a cross-sectional view of the foot cover of FIG. 47 taken along line 51-51 of FIG. 48.

FIG. 52 is a bottom perspective view of the foot cover of FIG. 47.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment may be omitted in order to facilitate a less obstructed view of these various embodiments of the present invention. Certain actions and/or steps may be described or depicted in a particular order of occurrence when such specificity with respect to sequence is not actually required. The terms and expressions used herein have the ordinary technical meaning as is accorded to such terms and expressions by persons skilled in the technical field as set forth above except where different specific meanings have otherwise been set forth herein.

Further, the following description of illustrative embodiments according to principles of the present disclosure is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to certain embodiments. Accordingly, the invention expressly should not be limited to such embodiments illustrating some possible non-limiting combination of features that may exist alone or in other combinations of features.

### DETAILED DESCRIPTION

Generally speaking, pursuant to these teachings, ladder feet, ladder foot assemblies, and ladders according to some embodiments disclosed herein may include a ladder footpad that increases the stability of a ladder during use. More specifically, the ladder footpad may, in some embodiments, include a curved bottom side with at least one curvature. In some approaches, the bottom side defines both a first curvature and a second curvature, which may be orthogonal to one another in some configurations. Advantageously, the curvature of the footpad increases the stability of the ladder, particularly on uneven surfaces, and lessens rocking during use of the ladder.

In an illustrative approach, a footpad for a ladder includes a top side and a bottom side, the bottom side defining treading. The footpad also may include four additional sides, such as a front side, a rear side, an inner side, and an outer side. In embodiments, the bottom side is curved, defining a first curvature and a second curvature. For instance, the first curvature may be defined substantially from the inner side to the outer side and the second curvature may be defined substantially from the front side to the rear side.

In some aspects, a ladder foot or ladder foot assembly is provided, the ladder foot or ladder foot assembly including an elongated foot component and a footpad. In an illustrative approach, the foot component includes a base defining a bottom side of the foot component and a rail insert portion extending from the base and sized to be at least partially received within a ladder rail. In embodiments, the footpad is attached to the base at the bottom side of the foot component and includes a curved bottom having at least two curvatures.

In some approaches, the ladder foot assembly further includes a ladder rail defining a channel, the rail insert portion of the foot component being at least partially received within the channel of the rail and coupled thereto. In some examples, the foot component is part of a brace, the brace including the foot component and a brace component extending from the foot component at an angle with respect to the foot component, the brace component sized and positioned to be coupled to a ladder rung.

In another illustrative approach, a ladder may include at least one ladder section comprising a first rail and a second rail and at least one rung connecting the first rail and the second rail; and a ladder foot at a bottom end of the first rail. In embodiments, at least one or at least two of the ladder feet include an elongated foot component and a footpad, the foot component having a base defining a bottom side of the foot component and a rail insert portion extending from the base and received at least partially within the first rail. In various approaches, the footpad may be attached to the base at the bottom side and define a curved bottom having at least two curvatures.

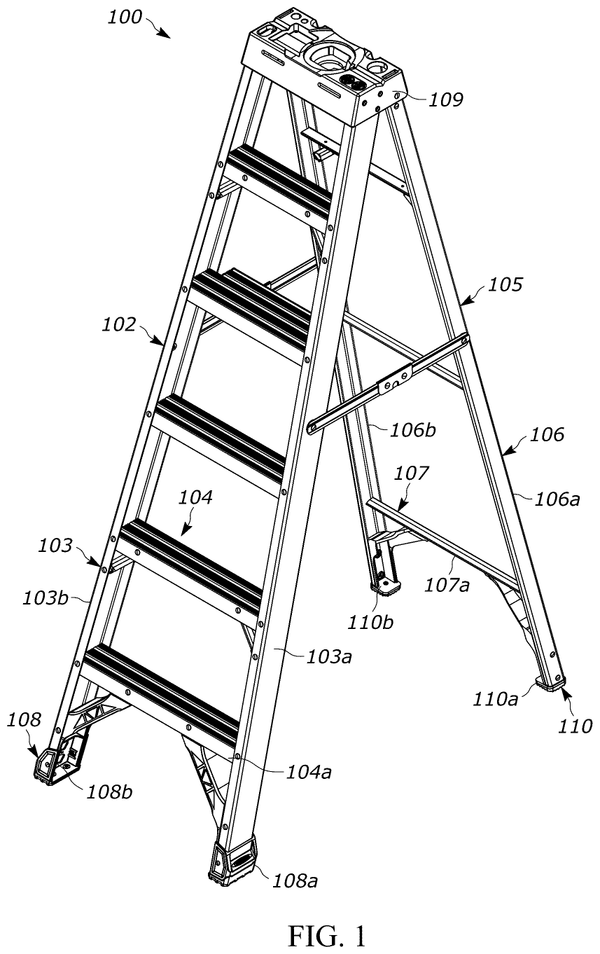

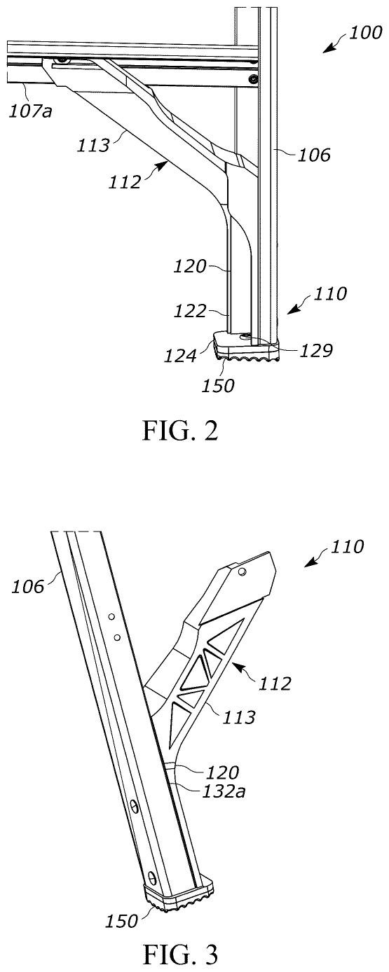

As shown generally in FIGS. 1 and 2, there is an exemplary ladder 100 that includes a ladder foot or ladder foot assembly 110 having a curved footpad 150. In some implementations, the curved footpad 150 improves stability of the ladder 100 and lessens rocking or other movement on uneven surfaces. While a stepladder is illustrated, it is contemplated that the ladder foot assembly 110 and/or curved footpad 150 may be used on a variety of different types of ladder known in the art, including but not limited to straight ladders, extension ladders, and multi-position ladders.

The exemplary ladder 100 includes a first or front ladder section 102 and a second or rear ladder section 105. The first or front ladder section 102 includes two front rails 103, including a first rail 103a and a second rail 103b spaced from one another, and one or more steps or rungs 104 extending between the first rail 103a and the second rail 103b. The second or rear ladder section 105 includes two rear rails 106, including a first rail 106a and a second rail 106b spaced from one another. The rear ladder section includes one or more rungs 107 extending between the first rail 106a and the second rail 106b. In the illustrated embodiment, the second or rear ladder section 105 is not configured for climbing, and, thus, the rungs 107 are horizontal supporting braces and not configured as steps. However, it is also contemplated that the second or rear ladder section 105 is a climbing section and the rungs 107 are configured as steps. As used herein, the term “rung” may refer to steps or horizontal supporting braces.

Though not present in the illustrated embodiment, in some embodiments the lengths of the rails 103a, 103b of the front ladder section 102 and/or the rails 106a, 106b of the rear ladder section 105 may be adjustable, for example by telescoping or sliding sets of rails.

The ladder 100 may include hinges (not shown), for example at or just below a “top” portion 109 of the ladder 100 between the front ladder section 102 and the rear ladder section 105, so that the rails 103 of the front ladder section 102 can pivot or rotate relative to the rails 106 of the rear ladder section 105 to a desired angle. For instance, in embodiments, the ladder 100 may be adjusted into a stepladder or A-line position as shown in FIG. 1 or to a folded or leaning step ladder configuration. In other embodiments, other positions may be possible such as an extended straight position, an extended stepladder position, or an L or substantially L-shaped position of the ladder.

In the illustrated approach, the ladder 100 includes front foot assemblies 108 at the front ladder section 102 and rear foot assemblies 110 at the rear ladder section 105. For instance, a first front foot assembly 108a may be disposed at or adjacent a free or bottom end of the first front rail 103a and a second front foot assembly 108b may be disposed at or adjacent a free or bottom end of the second front rail 103b. Further, a first rear foot assembly 110a may be disposed at or adjacent a free or bottom end of the first rear rail 106a and a second rear foot assembly 110b may be disposed at or adjacent a free or bottom end of the second rear rail 106b. In some approaches, the foot assemblies 108a, 108b, 110a, 110b may all be the same. In some approaches, the front foot assemblies 108 may be different from the rear foot assemblies 110. For instance, the front foot assemblies 108 and rear foot assemblies 110 may include similar components having different dimensions. For instance, in one approach the front foot assemblies 108 are larger or wider for bearing weight of users climbing the front ladder section 102. In some examples, the front foot assemblies 108 and rear foot assemblies 110 include different types or numbers of components and have different dimensions.

Further, while foot assembly 110 is illustrated and described herein as a rear foot assembly, it will be appreciated that the foot assembly 110 and footpad 150 included in the foot assembly 110 can also be used as a front foot assembly, or can be used with a ladder having only one set of feet.

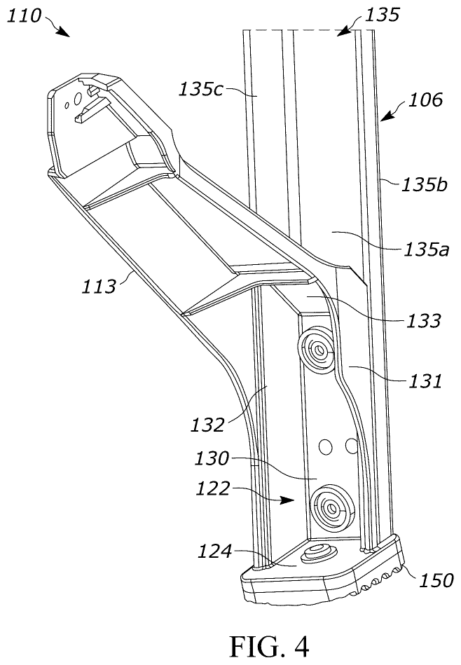

With reference to FIGS. 2-5, the rear foot assembly 110 may include an elongated foot component 120 and a footpad 150 attached to the elongated foot component 120. More specifically, the foot component 120 may include a base 124 defining a bottom of the foot component and a rail insert portion 122 extending upward from the base 124 and sized to be at least partially received within the rear rail 106. The footpad 150 may be attached to a bottom side 126 of the base 124 and have a curved bottom, as described further below.

In some approaches, the foot component 120 is part of a brace 112. The brace 112 may be a “combination” brace, that is, a single piece that defines both the foot component 120 and a brace component 113. For instance, in some approaches the brace component 113 extends from an end of the foot component 120 at an angle with respect to the foot component 120 and is sized and positioned to be coupled to a ladder rung, such as, for example, a bottom-most rung 107a. Thus, the brace 112 provides strengthening and support to the bottom rung 107a and rail 106 and also serves as a portion of the ladder foot to which a footpad can be attached. As illustrated, the angle defined between the foot component 120 and the brace component 113 of the brace 112 may be greater than 90 degrees. For instance, in various approaches, the angle may be greater than 100 degrees, greater than 110 degrees, or greater than 120 degrees.

In an illustrative approach, the braces described herein are molded plastic components, for instance, formed from polypropylene or other polymer materials. In other approaches, the braces may be metal components, for instance formed from aluminum or steel.

In embodiments, the rail insert portion 122 of the foot component 120 includes a main web 130, a first flange 131 extending from and along one side of the web 130, and a second flange 132 extending from and along an opposite side of the web 130, the first and second flanges 131, 132 spaced from and facing one another (e.g., substantially parallel to one another). In various approaches, the rail 106 is a C-shaped rail or has at least portions with a c-shaped cross section having a main web 135a, a first flange 135b extending from and along one side of the web 135a, and a second flange 135c extending from and along an opposite side of the web 135a, the first and second flanges 135b, 135c spaced from and facing one another (e.g., substantially parallel to one another). The main web 135a, the first flange 135b, and the second flange 135c of the rail 106 typically define a channel 135 sized to receive at least a portion of the rail insert portion 122 of the foot component 120. For instance, in some configurations, the main web 130 of the rail insert portion 122 may be inserted within the channel 135 and disposed proximate or in contact with the main web 135a of the rail 106 while the first and second flanges 131, 132 of the rail insert portion 122 may be inserted within the channel 135 and disposed proximate or in contact with the first and second flanges 135b, 135c of the rail 106.

As shown, the base 124 of the foot component 120 may be wider than the channel 135 of the rail 106 so that the base is not inserted in the rail 106. Instead, the widened base 124 may define a ledge 124a extending at a bottom of the web 130, first flange 131, and second flange 132 of the rail insert portion 122 which an end of the rail 106 may be seated upon or positioned slightly above. In some approaches, the first and second flanges 131, 132 of the rail insert portion 122 each define a step 122a and a cut-out 122b. The first and second flanges 135b, 135c of the rail 106 may be sized to fit within the cut-out 122b and may either abut or be slightly spaced from the step 122a.

As illustrated, the web 130 of the rail insert portion 122 and the web 135a of the rail 106 may each include one or more respective holes 141, 143 that align when the rail insert portion 122 is properly inserted into and seated within the channel 135 of the rail 106. One or more corresponding fasteners 142 (e.g., bolts, screws, or others) may extend through the holes 141, 143 to fix the rail insert portion 122 to the rail 106. For instance, the web 130 of the rail insert portion 122 may include two holes 141 that align with two holes 143 of the web 135a of the rail 106, and two fasteners 142 extending therethrough. Other amounts of holes and amounts of fasteners are possible. In some approaches, one or more of the holes 141, 143 may alternatively or additionally be disposed in the first and/or second flanges 131, 132 of the rail insert portion 122 and the first and/or second flanges 135b, 135c of the rail 106, respectively.

In some approaches, the brace 112 includes a top portion 133 or top side extending over a top end of the rail insert portion 122 and along the brace component 113. The brace component 113 may include, at least, the top portion 133 and at least one side wall 136 extending downwardly from the top portion 133. The at least one side wall 136 may be substantially continuous with one of the flanges 131, 132 of the rail insert portion 122 and may extend at an angle therefrom. In some approaches, the flange 132 of the foot component 120 curves to form the side wall 136 of the brace component 113. The brace component 113 includes a fastening flange 137 at a distal end thereof which may include one or more holes for fastening to the rung 107a. The fastening flange 137 may be positioned, for example, to engage a lower flange of the bottom rung 107a (or, in other approaches, a side wall or bottom of the rung). In some embodiments, the fastening flange 137 extends from the side wall 136. In some approaches, such as described below with respect to ladder foot assembly 208, there may be two side walls (e.g., generally opposing one another) and two fastening flanges of the brace component 113.

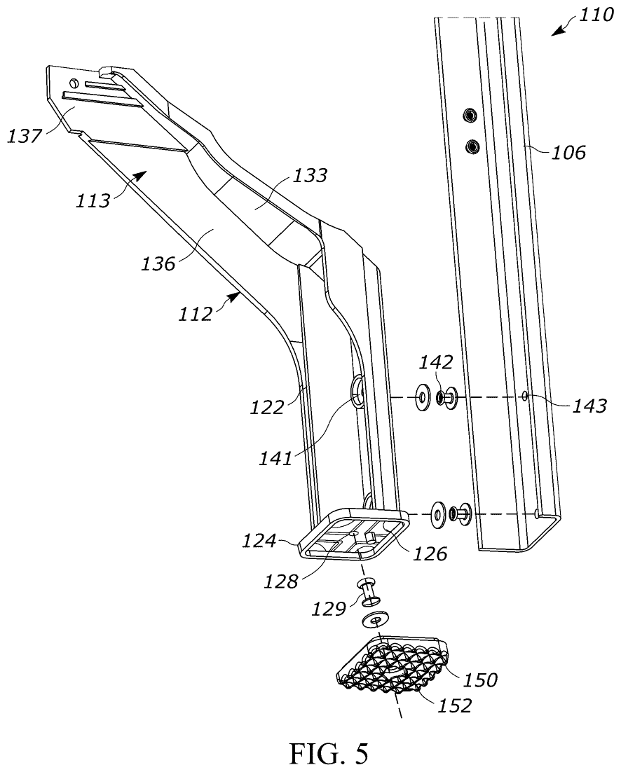

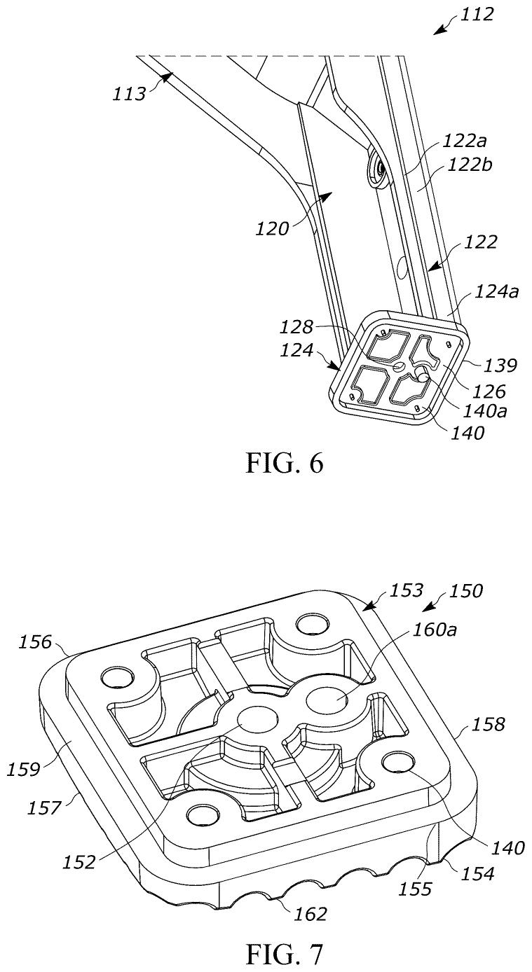

With reference to FIGS. 5-7, the base 124 of the elongated foot component 120 may have a slim, generally flat profile and may have a geometry that corresponds generally to a geometry of the footpad 150. For example, in the illustrated embodiment, the base 124 and the footpad 150 have a generally square shape and have substantially the same width and length so that the edges of each component align. In other embodiments, the shapes may be rectangular. Other shapes are possible. In some embodiments, a central hole 128 extends through the base 124 from a top side 125 of the base 124 to a bottom side 126 of the base 124. A fastener 129 may extend through the hole 128 and a corresponding central hole 152 of the footpad 150 to couple the footpad 150 to the base 124. In some embodiments, there may be two holes in each of the base 124 and the footpad 150 for fasteners. The number and position of the holes and fasteners for coupling the footpad 150 to the base 124 is not particularly limited. In other approaches, other forms of coupling are possible, such as gluing, adhesive, friction fit, welding, or co-molding the base 124 and pad 150.

In some embodiments, the base 124 and the footpad 150 may have interlocking features which help to maintain contact between the engaging surfaces of the base 124 and footpad 150 and to maintain proper alignment or positioning of the footpad 150 with respect to the base 124. For instance, the bottom 126 of the base 124 may include one or more projections, recesses, or other interlocking elements 140 that interlock with one or more complementary projections, recesses, or other interlocking elements 160 disposed at a top side 153 of the footpad 150. For example, as shown, the base 124 may include an off-center interlocking post 140a that is sized to be received within a complementary hole 160a of the footpad 150 for proper registration and alignment. As shown, the base 124 may also include an arrangement of ribs and/or posts and negative space therebetween that interlock with complementary negative space and ribs and/or posts of the footpad 150. For instance, in the illustrated approach, the base 124 includes four posts adjacent the corners of the base 124 that interlock with four holes adjacent the corners of the footpad 150 and four ribs arranged about the central hole 128 that engage complementary recessed portions of the footpad 150. Other arrangements are possible. As illustrated, the base 124 may also include a peripheral downturned flange 139 that may engage or interlock with a complementary peripheral recessed portion 159 at the top 153 of the footpad 150.

In embodiments, the footpads disclosed herein may be formed from a plastic, rubber, or other suitable material that exhibits some flexibility, compressibility, and/or softness. In an exemplary, non-limiting approach, the footpads may be formed from a flexible polyvinyl chloride material. Other elastomeric materials can be used, such as materials that exhibit a low modulus of elasticity and/or up to one thousand percent of elastic deformation.

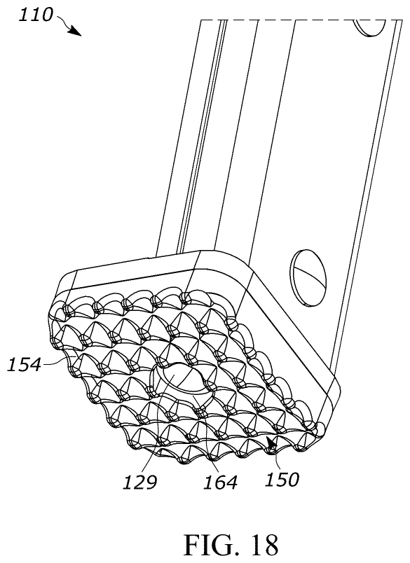

As noted above, the footpad 150 may have a generally square or rectangular shape, though other shapes are possible. The footpad 150 defines a top side 153, a bottom side 154 opposite the top side 153, and four sides extending between the top side 153 and the bottom side 154, such as a first side 155, a second side 156, a third side 157, and a fourth side 158. When positioned on the foot assembly 110 and ladder, the first side 155 may be a front side, the second side 156 may be a rear side, the third side 157 may be an inner side, and the fourth side 158 may be an outer side. As noted above, a hole 152 may extend through the footpad 150 from the top side 153 to the bottom side 154 for receiving a fastener. As shown in FIGS. 9 and 16-18, the hole 152 may be sunken in or recessed with respect to the bottom side 154. For instance, the bottom side 154 may include a central recess 164, and the hole 152 may extend from the bottom of the recess 164 to the top side 153. The recess 164 provides extra space at the bottom side 154 of the footpad 150 for a head of a fastener so that the fastener does not come in contact with the ground.

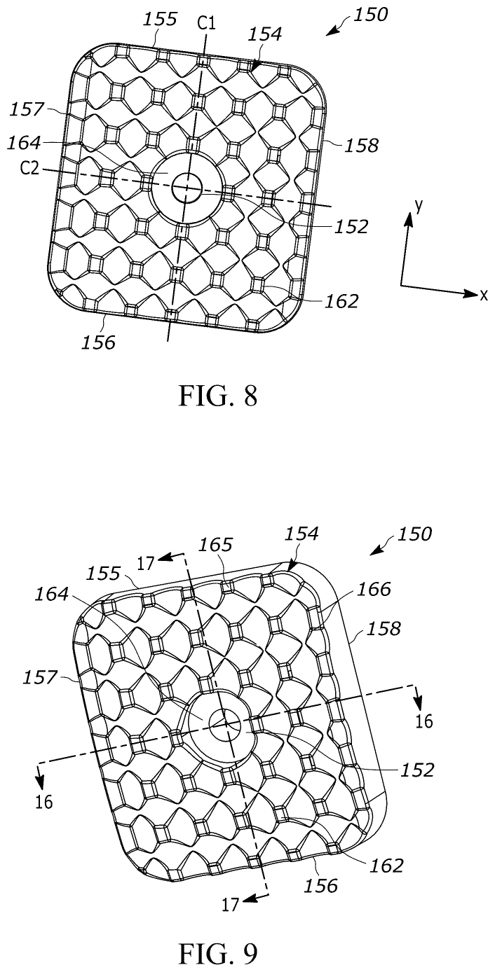

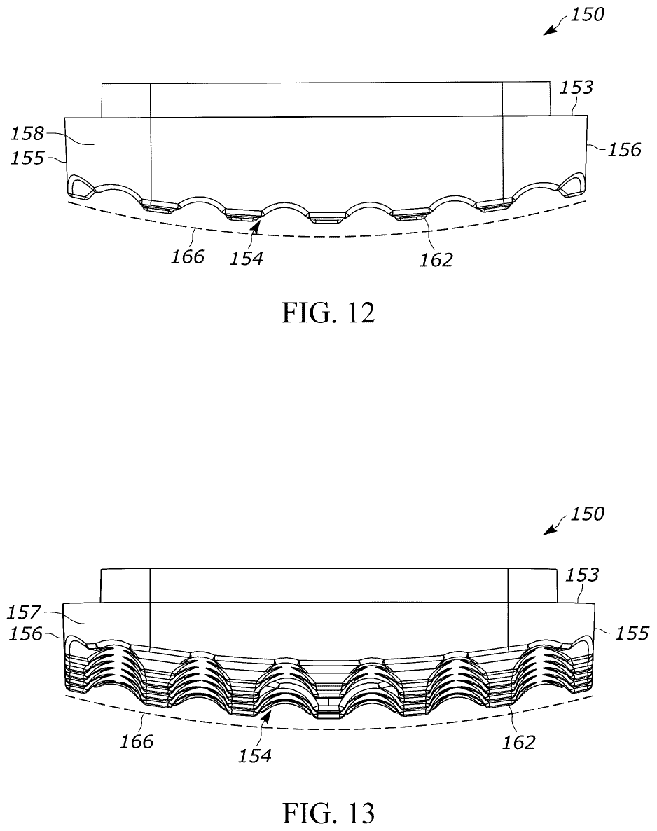

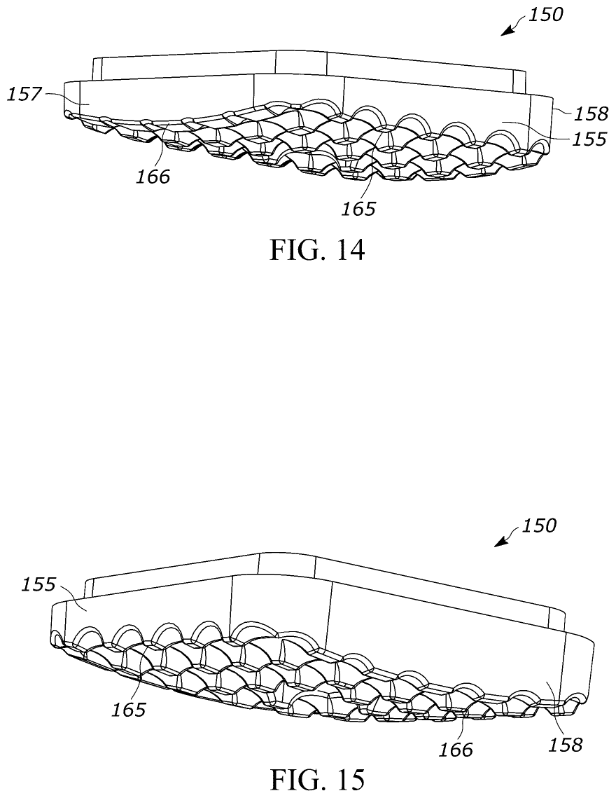

With reference to FIGS. 8-17, the bottom side 154 of the footpad 150 includes treading or treads 162. In an illustrative approach, the treads 162 are formed integrally with the footpad 150. In some embodiments, the treading 162 may be configured to provide grip, traction, or resistance to movement in two different directions. For example, as shown, the treads may be discrete treads spaced in a grid or waffle pattern to resist movement in both the x direction and the y direction to prevent the ladder from slipping in the x and y direction during use. The treads may also be present in other patterns. In an illustrative embodiment, the treading extends all the way to the sides 155, 156, 157, 158 of the footpad 150 such that the sides 155, 156, 157, 158 partially define the outermost treads. The treading 162 extending all the way to the sides 155, 156, 157, 158 advantageously provides extra traction from the side if the footpad 150 is positioned against a wall or other object.

As noted above, the bottom side 154 of the footpad 150 is curved. For instance, the bottom side 154 may have at least one curvature extending substantially from one side of the footpad 150 to the opposite side of the footpad 150. For instance, the bottom side 154 may define a curvature from the first or front side 155 to the second or rear side 156, or a curvature from the third or inner side 157 to the fourth or outer side 158. In illustrative approaches, the bottom side 154 defines two different curvatures. For instance, as shown, the bottom side 154 may define a first curvature 165 extending from the first or front side 155 to the second or rear side 156, and a second curvature 166 extending from the third or inner side 157 to the fourth or outer side 158.

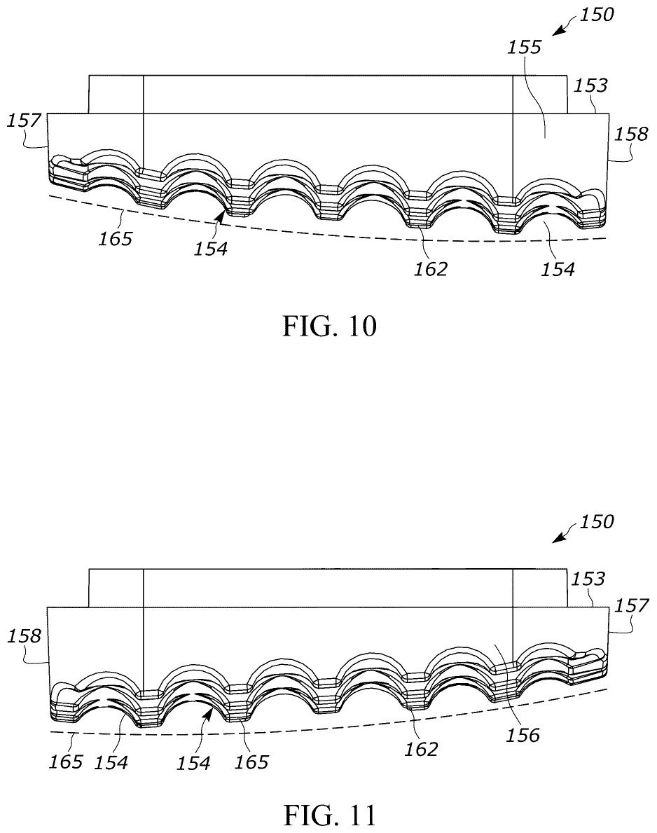

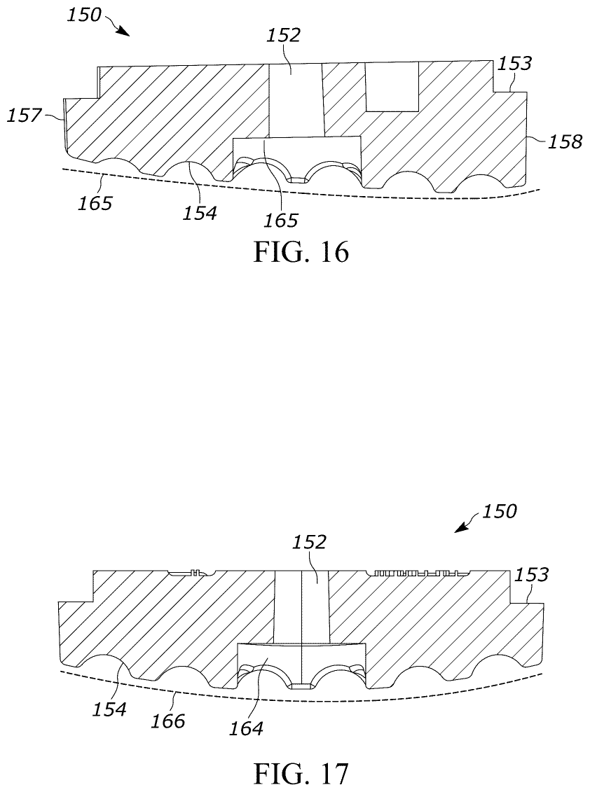

In some approaches, the first and second curvatures 165, 166 may have the same curvature. In other approaches, the first and second curvatures 165, 166 may be different. In the illustrated approach, for example, the first curvature 165 is asymmetric about a first centerline C1 while the second curvature 166 is generally symmetric about a second centerline C2. For instance, as shown most clearly in FIGS. 10, 11, 14, and 16, the first curvature 165 has a generally downward curvature from the inner side 157 to the outer side 158, such that the thickness of the footpad 150 generally increases from the inner side 157 to the outer side 158, and thus may have a generally conical profile. In other words, the first curvature 165 may define a gradual tapering of the footpad 150 from the outer side 158 to the inner side 157 so that the footpad is thinnest adjacent the inner side 157 and thickest adjacent the outer side 158. While FIG. 16 shows a centrally-taken cross-section that illustrates the first curvature 165, it is contemplated that the first curvature 165 may be the same across all cross-sections between the inner side 157 and the outer side 158 (e.g., the first curvature is uniform from each point on the inner side 157 to each corresponding point on the outer side 158).

In some approaches, the tapering from the outer side 158 to the inner side 157 as a result of the first curvature 165 may increase the stability of the ladder by reducing bowing out of the rails under a load. More specifically, the tapering at the inner side 157 increases the contact patch of the foot under load and toes the foot inward to lessen bowing.

With reference to FIGS. 8, 12, 13, 15, and 17, the second curvature 166, on the other hand, may have a more spherical profile, being generally symmetric about the second centerline C2 from the front side 155 to the rear side 156 so that the bottom side 154 curves downward from the front side 155 to the centerline C2 and then back upward from the centerline C2 to the rear side 156. Thus, the footpad 150 may progressively thicken from the front side 155 to the centerline C2 and from the rear side 156 to the centerline C2. While FIG. 17 shows a centrally-taken cross-section that illustrates the second curvature 166, it is contemplated that the second curvature 166 may be the same across all cross-sections between the front side 155 and the rear side 156 (e.g., the second curvature is uniform from each point on the front side 155 to each corresponding point on the rear side 156).

The exact values of the first and second curvatures 165, 166 may depend, in different approaches, on the dimensions of the footpad 150 (e.g., the lengths of the sides 155, 156, 157, 158). However, in illustrative approaches, the lengths of each of the sides 155, 156, 157, 158 is between about 1 to 4 inches, or about 1.5 to 2.5 inches. In some approaches, all four sides may have the same, or about the same length. In some configurations, the sides 155, 156 may have a different length from sides 157, 158 so the footpad 150 is rectangular. In one approach, for example, the sides 155, 156 are about 1.89 inches, the radius of curvature of the first curvature is about 4.8 inches, the sides 157, 158 are about 1.96 inches, and the radius of curvature of the second curvature is about 4.5 inches. In some configurations, the radius of curvature of the first curvature may be about 2 inches to about 8 inches while the radius of curvature of the second curvature may be about 1 inch to about 10 inches.

In various approaches, both the first and second curvatures 165, 166 may be generally symmetrical about a centerline of the footpad 150, or may both be asymmetrical about the centerline. In some embodiments, for instance, both the first and second curvature 165, 166 may define a gradual thickening or tapering of the footpad 150 from one side to its opposing side. Further, while in the illustrated embodiment the first curvature 165 generally tapers the footpad 150 from the outer side 158 to the inner side 157, it will be appreciated that in other approaches a similar curvature could occur from the front side 155 to the rear side 156, from the rear side 156 to the front side 155, or from the inner side 157 to the outer side 158. In some approaches, instead of one or both of the curvatures, the bottom 154 may define one or more angled tapers of the footpad 150. In some embodiments, the bottom contour may define an angled segment that gradually curves.

Advantageously, the multiple curvatures of the footpads described herein mitigate stability issues that commonly occur with ladders. For instance, even when ladders are used on a relatively flat ground, ladders tend to exhibit wobbliness. A footpad with multiple slight curvatures, however, permits the footpad to adapt precisely to the specific points of an uneven surface, reducing wobble and rendering the ladder more stable during use.

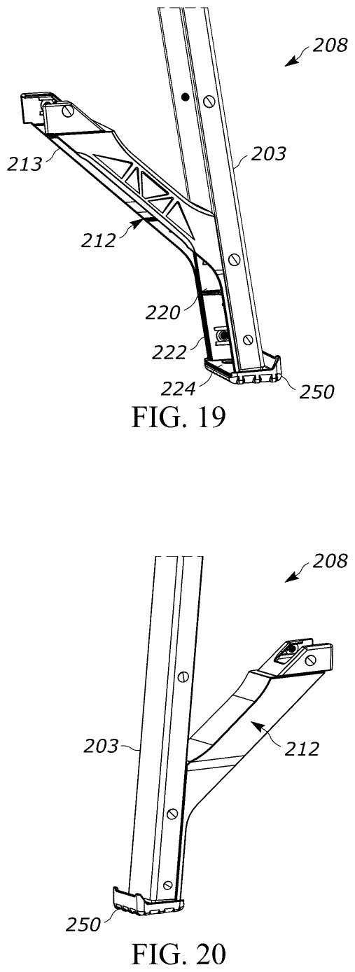

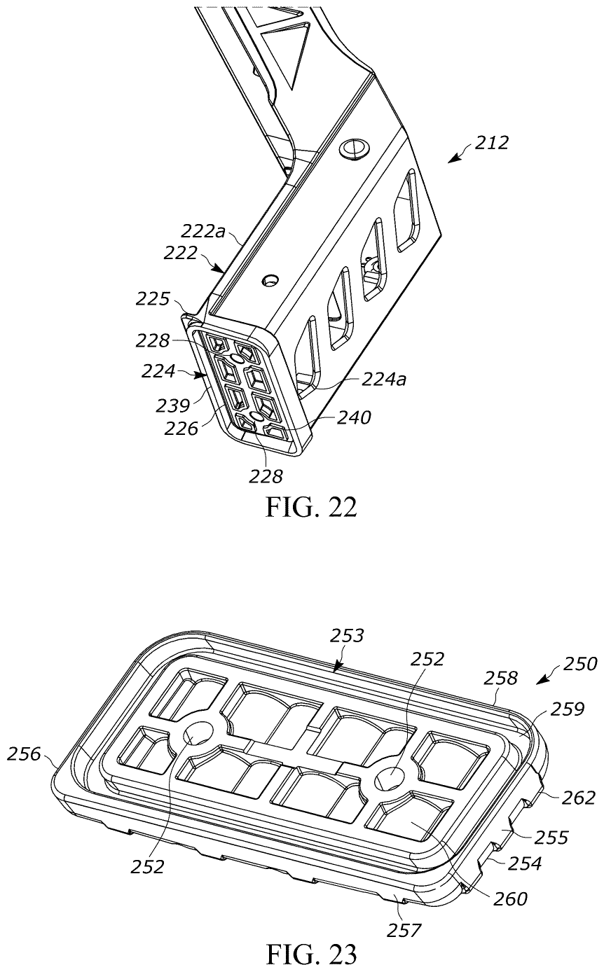

With reference to FIGS. 19-22, another ladder foot assembly 208 that includes a curved footpad 250 is shown. Many of the features of the ladder foot assembly 208 are the same as those discussed above for rear foot assembly 110. The common features may not be specifically referenced in this description of ladder foot assembly 208 but are incorporated by reference and will be denoted with the same number except that the number will begin with a “2”.

In some approaches, the foot assembly 208 is a front foot assembly for a front section of a stepladder, such as stepladder 100. More specifically, front foot assembly 208 and footpad 250 differ from rear foot assembly 110 and footpad 150 by having a different shape and size. For instance, the footpad 250 is larger, rectangular, and is longer in the front-to-rear direction. The differences in size and shape make footpad 250 more effective in bearing weight on the climbing side of the stepladder. However, it will be appreciated that the foot assembly 208 and footpad 250 described below can also be used as a rear foot assembly in certain embodiments, or can be used with a ladder having only one set of feet.

Like foot assembly 110, the foot assembly 208 may include an elongated foot component 220 and a footpad 250 attached to the elongated foot component 220. More specifically, the foot component 220 may include a base 224 defining a bottom of the foot component and a rail insert portion 222 extending upward from the base 224 and sized to be at least partially received within rail 203 (e.g., a front rail). The footpad 250 may be attached to a bottom side 226 of the base 224 and have a curved bottom, as described further below.

The foot component 220 may be part of a brace 212, which is similar in some respects to brace 112. The brace 212 is a combination brace that defines both the foot component 220 and a brace component 213 that extends at an angle from the foot component 220 and fastens to a bottom-most rung (e.g., such as bottom-most rung 104a in FIG. 1). As shown, the brace component 213 may be different from brace component 113 by having two side walls 236a, 236b that extend downwardly from a top portion 233 and two fastening flanges 237a, 237b that extend, respectively, from the two side walls 236a, 236b. In some approaches, these flanges 237a, 237b are positioned to be attached to two downwardly extending flanges of the rung.

In embodiments, the rail insert portion 222 of the foot component 220 includes a main web 230, a first flange 231 extending from and along one side of the web 230, and a second flange 232 extending from and along an opposite side of the web 230, the first and second flanges 231, 232 spaced from and facing one another (e.g., substantially parallel to one another). In various approaches, the rail 203 (or at least portions thereof) is a C-shaped rail having a main web 235a, a first flange 235b extending from and along one side of the web 235a, and a second flange 235c extending from and along an opposite side of the web 235a, the first and second flanges 235b, 235c spaced from and facing one another (e.g., substantially parallel to one another). The main web 235a, the first flange 235b, and the second flange 235c of the rail 203 define a channel 235 sized to receive at least a portion of the rail insert portion 222 of the foot component 220. For instance, in some configurations, the main web 230 of the rail insert portion 222 may be inserted within the channel 235 and disposed proximate or in contact with the main web 235a of the rail 206 while the first and second flanges 231, 232 of the rail insert portion 222 may be inserted within the channel 235 and disposed proximate or in contact with the first and second flanges 235b, 235c of the rail 203.

As illustrated, the first and second flanges 231, 232 of the rail insert portion 222 and the first and second flanges 235b, 235c of the rail 203 may each include one or more respective holes 241, 243 that align when the rail insert portion 222 is properly inserted into the channel 235 of the rail 203. One or more corresponding fasteners (not shown) (e.g., bolts, screws, or others) may extend through the holes 241, 243 to fix the rail insert portion 222 to the rail 203. For instance, the first and second flanges 231, 232 of the rail insert portion 222 may each include two holes 241 that align with two respective holes 243 of each of the first and second flanges 235b, 235c of the rail 203, with fasteners extending therethrough. Other amounts of holes and amounts of fasteners are possible. In some approaches, one or more of the holes 241, 243 may alternatively or additionally be disposed in web 230 of the rail insert portion 222 and in the web 235a of the rail 203.

As shown, the base 224 of the foot component 220 may be wider than the channel 235 of the rail 203 so that the base 224 is not inserted in the rail 203. Instead, the widened base 224 may define a ledge 224a extending at a bottom of the web 230, first flange 231, and second flange 232 of the rail insert portion 222 which an end of the rail 203 may be seated upon or positioned slightly above. In some approaches, the first and second flanges 231, 232 of the rail insert portion 222 each define a step 222a. The first and second flanges 235b, 235c of the rail 106 may be sized to fit closely around the rail insert portion 222 and may either abut or be slightly spaced from the step 222a.

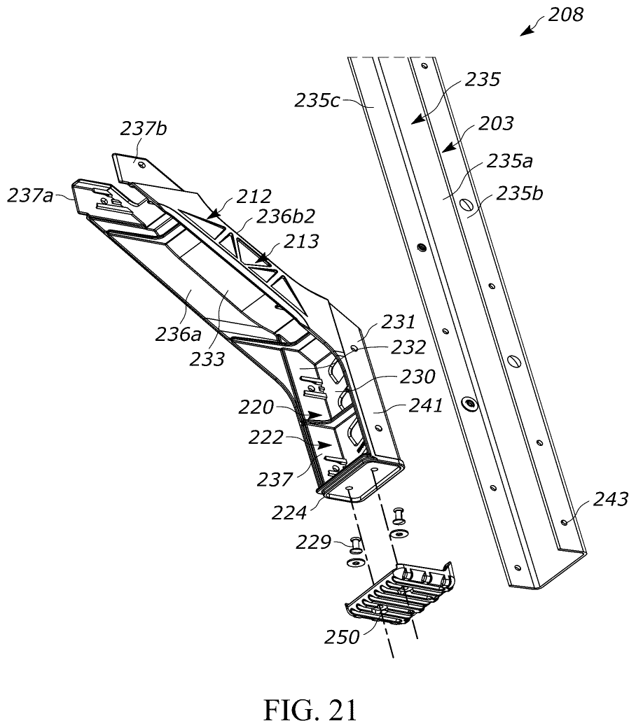

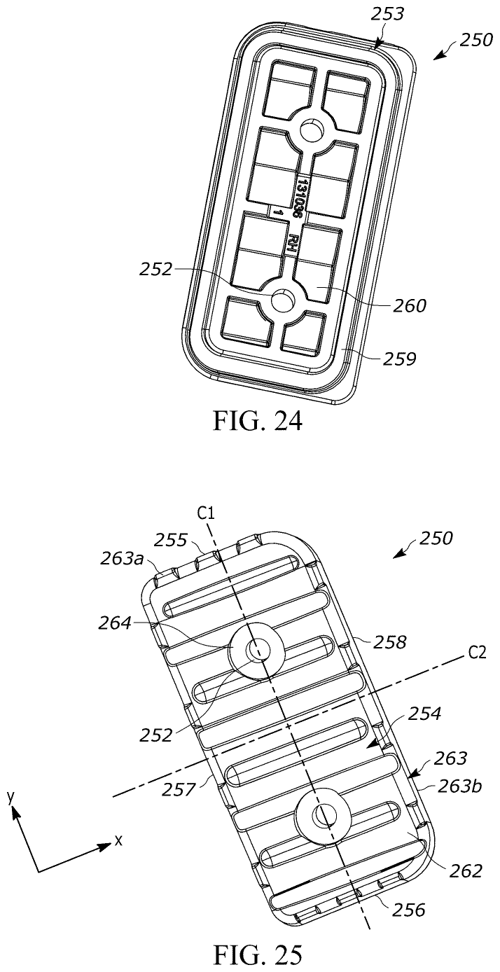

With reference to FIGS. 21-24, the base 224 of the foot component 220 may be generally flat and may have a geometry that corresponds generally to a geometry of the footpad 250. For example, in the illustrated embodiment, the base 224 and the footpad 250 have a generally rectangular shape and have substantially the same width and length so that the edges of each component align. Other shapes are possible. In some embodiments, one or more holes 228 extend through the base 224 from a top side 225 of the base 224 to a bottom side 226 of the base 224. For instance, there may be two holes 228 spaced along a centerline of the base 224. Fasteners 229 may extend through the holes 228 and corresponding holes 252 of the footpad 250 to couple the footpad 250 to the base 224. The number and position of the holes and fasteners is not particularly limited. In other approaches, other forms of coupling are possible, such as gluing, welding, or co-moulding the brace 212 and pad 250.

In some embodiments, the base 224 and the footpad 250 may have interlocking features which help to maintain contact between the engaging surfaces of the base 224 and footpad 250 and to maintain proper alignment or positioning of the footpad 250 with respect to the base 224. For instance, the bottom 226 of the base 224 may include one or more projections, recesses, or other interlocking elements 240 that interlock with one or more complementary projections, recesses, or other interlocking elements 260 disposed at a top side 253 of the footpad 250. For example, as shown, the base defines a downwardly extending peripheral flange 239 that may engage or interlock with a complementary peripheral recessed portion 259 at the top 253 of the footpad 250. In addition, the base 224 includes an arrangement of ribs and coring/negative space that interlocks with complementary coring/negative space and ribs of the footpad 250. For instance, in the illustrated approach, the base 224 includes two columns of ribs arranged on either side of the holes 228 that engage complementary recessed portions of the footpad 250. Other arrangements are possible.

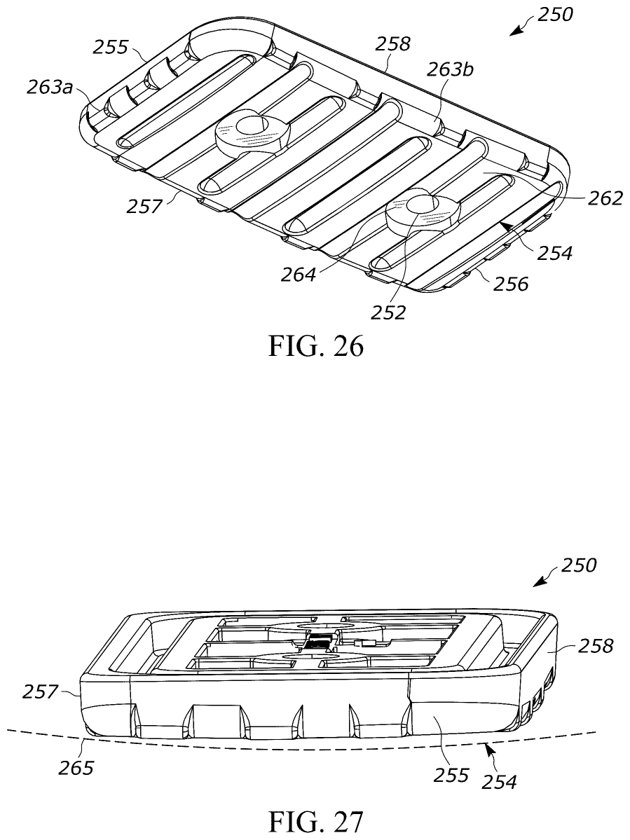

As noted above, the footpad 250 has a generally rectangular shape, and defines a top side 253, a bottom side 254 opposite the top side 253, and four sides extending between the top side 253 and the bottom side 254, such as a first side 155, a second side 256, a third side 257, and a fourth side 258. When positioned on the foot assembly 208 and ladder, the first side 255 may be a front side, the second side 256 may be a rear side, the third side 257 may be an inner side, and the fourth side 258 may be an outer side. As noted above, holes 252 may extend through the footpad 250 from the top side 253 to the bottom side 254 for receiving fasteners. As shown in FIGS. 26, the holes 252 may be sunken in or recessed with respect to the bottom side 254. For instance, the bottom side 254 may include recesses 264, and the holes 252 may extend from the bottom of the recesses 264 to the top side 253. The recesses 264 provide extra space at the bottom side 254 of the footpad 250 for a head of a fastener so that the fastener is sunken in and does not come in contact with the ground. The footpad 250 may also be coupled to the base 224 in other ways, such as by gluing, welding, or co-molding.

With reference to FIGS. 25 and 26, the footpad 250 includes treading or treads 262. In an illustrative approach, the treads 262 are formed integrally with the footpad 250 and may be disposed on the bottom 254 of the footpad 250. In an illustrative embodiment, the footpad 250 also includes side treading 263 extending at least partially along one or more of the sides 255, 256, 257, 258 of the footpad 250. For instance, as illustrated, the side treads 263 may be present at a lower rounded edge between the sides 255, 256, 257, 258 and the bottom 254. More specifically, first side treads 263a may be disposed on sides 255 and 256 and second side treads 263b may be disposed on sides 257 and 258.

In some embodiments, the treading may be configured to provide grip, traction, or resistance to movement in two different directions. For example, as shown, the treads 262 at the bottom 254 of the footpad 250 may be elongated treads (e.g., alternating treads and grooves), each tread extending between the inner side 257 and the outer side 258, resisting movement in a first direction, such as the y direction. The first side treads 263a, disposed on sides 255 and 256, however, may include a plurality of treads positioned in a row, resisting movement of the foot and ladder in a second direction, such as the x direction. In some embodiments, the second side treads 263b disposed on sides 257 and 258 resist movement in the y direction. As shown, the side treads 263b may be at least partially offset from the treads 262 at the bottom 254 for extra traction. The treads may also be present in other configurations and patterns.

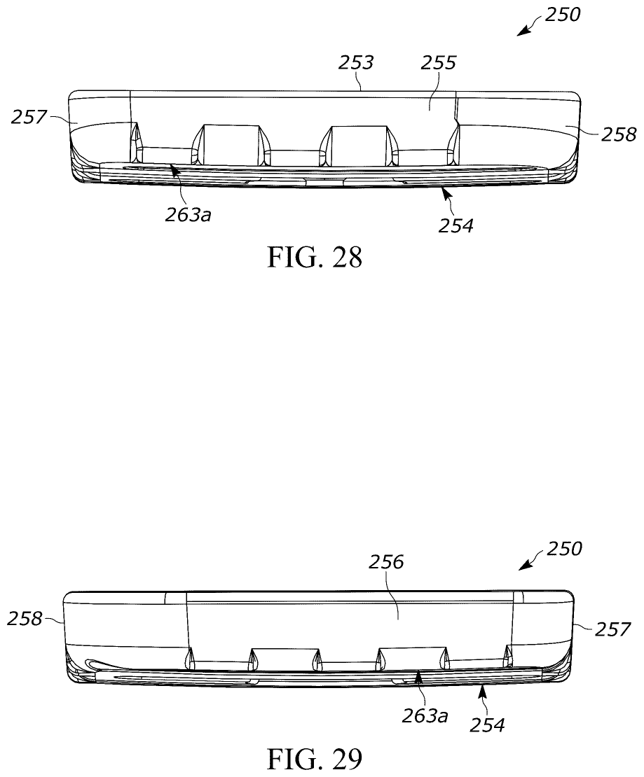

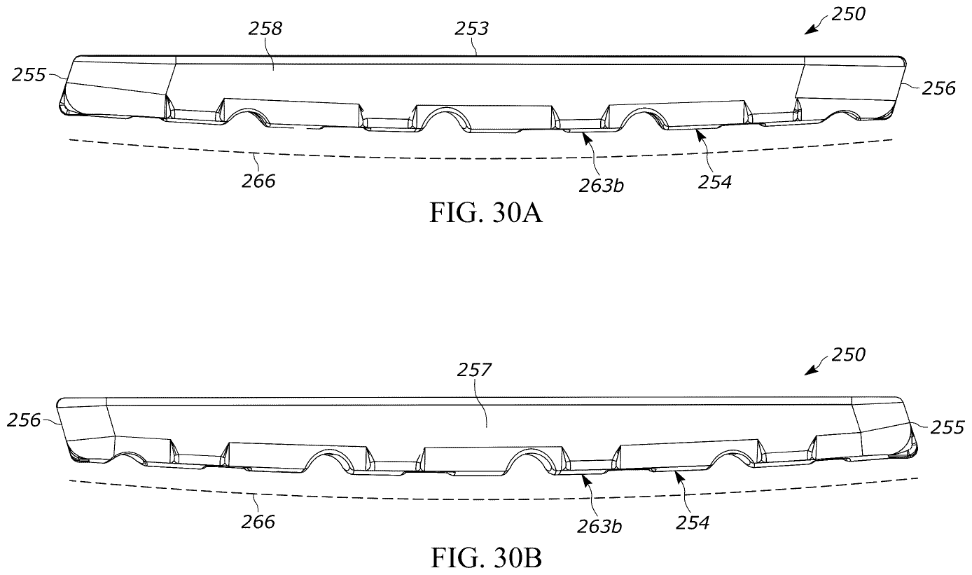

With reference to FIGS. 25-30B, the bottom side 254 of the footpad 250 is curved. For instance, the bottom side 254 may have at least one curvature extending substantially from one side of the footpad 250 to the opposite side of the footpad 250. For instance, the bottom side 254 may define a curvature from the first or front side 255 to the second or rear side 256, or a curvature from the third or inner side 257 to the fourth or outer side 258. In illustrative approaches, the bottom side 254 defines two different curvatures. For instance, as shown, the bottom side 254 may define a first curvature 265 extending from the first or front side 255 to the second or rear side 256, and a second curvature 266 extending from the third or inner side 257 to the fourth or outer side 258.

In some approaches, the first and second curvatures 265, 166 may have the same curvature. In other approaches, the first and second curvatures 265, 266 may be different. In the illustrated approach, for example, the first curvature 265 and the second curvature 266 are both generally symmetrical around centerlines C1 and C2, respectively, though may have different radii of curvature. For instance, as shown, the first curvature 265 generally curves downward from the inner side 257 to the centerline C1 and then back upward from the centerline C1 to the outer side 258, defining a partial spherical profile. Thus, the footpad 250 may progressively thicken from the inner side 257 to the centerline C1 and from the outer side 258 to the centerline C1. The second curvature 266 may be similarly configured, curving downward from the front side 255 to the centerline C2 and then back upward from the centerline C2 to the rear side 256.

In other embodiments, the first curvature 265 may be similar to the first curvature 165 described above, with a more conical, asymmetrical profile and a gradual tapering from one side to the other. For instance, the inner side 257 of the footpad 250 may be thinner than the outer side 258 due to the first curvature 265. In other approaches, the second curvature or both curvatures may have an asymmetrical profile and define a gradual tapering from one side to the other. In some approaches, instead of one or both of the curvatures, the bottom 254 may define one or more angled tapers of the footpad 250. In some embodiments, the bottom contour may define an angled segment that gradually curves.

The exact radii of curvature of the first and second curvatures 265, 266 may depend, in different approaches, on the dimensions of the footpad 250 (e.g., the lengths of the sides 255, 256, 257, 258). However, in illustrative approaches, the length of the sides 255, 256 is about 1.2 to 2.8 inches, for example about 1.65 inches, and the length of the sides 257, 258 is about 3 to about 4.5 inches, for example about 3.41 inches. In some approaches the radius of curvature of the first curvature is about 10 inches to about 25 inches, and the radius of curvature of the second curvature is about 10 inches to about 50 inches.

Generally speaking, further disclosed herein are ladder foot assemblies and footpads according to additional embodiments that expand or widen the base of a ladder and increase its stability while being relatively compact, robust, and simple in design. More specifically, the ladder foot assembly, in some embodiments, includes, in part, a footpad and a foot cover that extend beyond a dimension of the ladder rail to increase the footprint and stability of the ladder. In one illustrative configuration, the foot expands a width of the ladder rail to increase the footprint and stability of the ladder.

In an illustrative approach, a footpad for a ladder includes a main pad body defining a top side and a bottom side, the bottom side defining treading. The footpad also may include four additional sides extending between the top side and the bottom side, the four sides including a first side, a second side opposite of the first side, a third side, and a fourth side opposite the third side. In embodiments, the first side projects upwardly above the top side to provide a lip. In some approaches, the first side has a height that extends higher than respective heights of the second side, the third side, and the fourth side.

In some configurations, the first side is adjacent to the third side and the fourth side, and the third and fourth sides define in part upstanding walls projecting upwardly above the top side. The lip and the upstanding walls, thus, may define a partial receptacle therebetween for receiving a foot of a ladder. In some approaches, the lip has a greater height than the upstanding walls.

In some embodiments, the footpad also includes at least two posts extending upwardly from the lip. The footpad may also, in some examples, include one or more grooves or projections in the top side for interlocking with other components of a ladder foot assembly.

In some aspects, a ladder foot or ladder foot assembly is provided, the ladder foot or ladder foot assembly including a ladder rail (or a portion thereof), a rail insert inserted at a bottom end of the rail (defining an insert portion extending within a channel of the ladder rail) and a base. In addition, the ladder foot or ladder foot assembly also may include a footpad attached to the base and a cover extending at least in part about the ladder rail and engaging with the footpad. In some approaches, the footpad includes a lip that extends upwardly along an exterior side of the cover.

In some configurations, the footpad is larger and wider than a perimeter of the base of the rail insert and the ladder rail. By some approaches, the cover includes a lower portion that extends outwardly beyond the rail and that engages a portion of the footpad that extends beyond the base. In some configurations, the footpad includes a top side, a bottom side with treading, and four lateral sides, wherein the lip is formed from an upward extension of one of the lateral sides.

In illustrative approaches, the cover includes a web portion, a first flange extending from one end of the web portion, and a second flange extending from an opposite end of the web portion, the first flange generally facing the second flange and defining a channel for receiving the ladder rail. In some approaches, the exterior side of the cover includes a cutout shaped to receive a shape of the lip. In some examples, one or more pockets are defined in the cover extending upwardly from the cutout to receive one or more posts of the footpad extending upwardly from the lip.

In some configurations, the rail insert is part of a brace. For instance, in an exemplary configuration, the brace includes the rail insert and a brace component extending from the rail insert at an angle with respect to the rail insert, the brace component sized and positioned to be coupled to a ladder rung.

In some aspects, a ladder is provided herein, the ladder including at least one section having a first rail and a second rail and at least one rung connecting the first rail and the second rail, and a ladder foot at a bottom end of the first rail. The ladder foot, in exemplary configurations, includes a rail insert inserted at least in part within the first rail, a cover extending at least in part about the first rail, and a footpad attached to an end of the rail insert, the footpad including a lip that extends upwardly and engages the cover.

In some embodiments, the footpad of the ladder is fastened to a base of the rail insert and the cover includes one or more grooves or projections which interlock with one or more complementary grooves or projections of the footpad. In some approaches, the footpad is wider than a base of the rail insert and the first rail, and the cover includes a lower portion that extends outwardly from the first rail and engages a portion of the footpad that extends past the base.

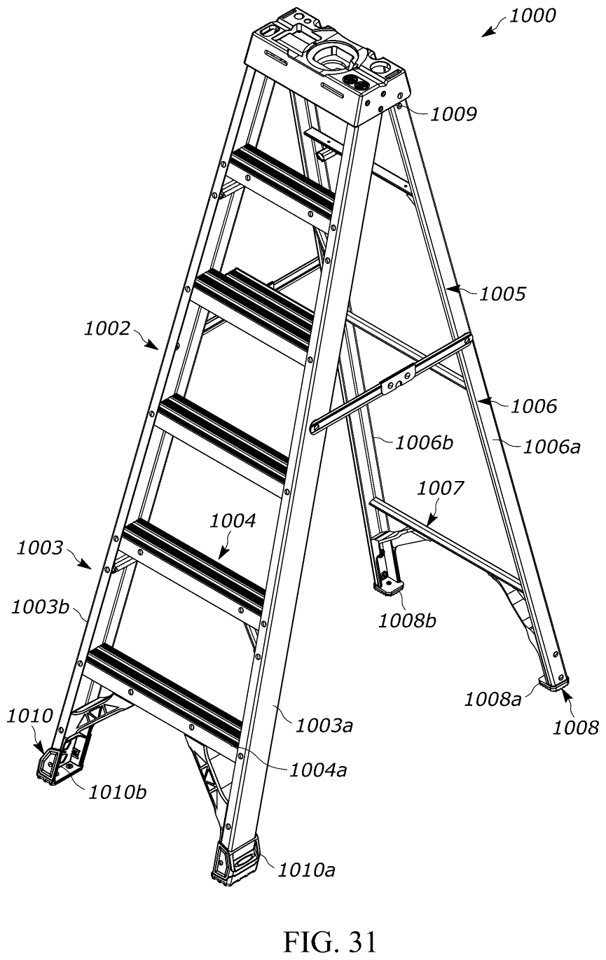

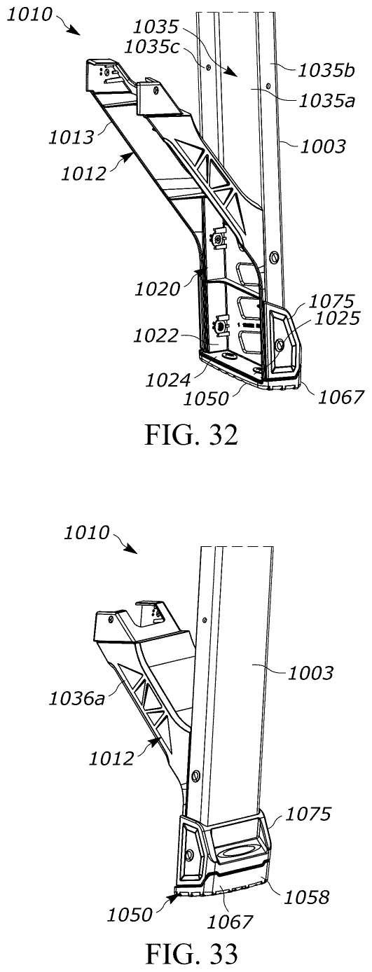

As shown generally in FIGS. 31 and 32, there is an exemplary ladder 1000 that includes a ladder foot or ladder foot assembly 1010 that expands the ladder's base and improves the stability of the ladder 1000. While a stepladder is illustrated, it is contemplated that the ladder foot assembly 1010 and/or components thereof may be used on a variety of different types of ladders known in the art, including but not limited to straight ladders, extension ladders, and multi-position ladders.

The exemplary ladder 1000 includes a first or front ladder section 1002 and a second or rear ladder section 1005. The first or front ladder section 1002 includes two front rails 1003, including a first rail 1003a and a second rail 1003b spaced from one another, and one or more steps or rungs 1004 extending between the first rail 1003a and the second rail 1003b. The second or rear ladder section 1005 includes two rear rails 1006, including a first rail 1006a and a second rail 1006b spaced from one another. The rear ladder section includes one or more rungs 1007 extending between the first rail 1006a and the second rail 1006b. In the illustrated embodiment, the second or rear ladder section 1005 is not configured for climbing, and, thus, the rungs 1007 are horizontal supporting braces and not configured as steps. However, it is also contemplated that the second or rear ladder section 1005 may be a climbing section and the rungs 1007 may be configured as steps. As used herein, the term “rung” may refer to steps or horizontal supporting braces between respective rails.

Though not present in the illustrated embodiment, in some embodiments the lengths of the rails 1003a, 1003b of the front ladder section 1002 and/or the rails 1006a, 1006b of the rear ladder section 1005 may be adjustable, for example by telescoping or sliding sets of rails.

The ladder 1000 may include hinges, for example at or just below a “top” portion 1009 of the ladder 1000 between the front ladder section 1002 and the rear ladder section 1005, so that the rails 1003 of the front ladder section 1002 can pivot or rotate relative to the rails 1006 of the rear ladder section 1005 to a desired angle. For instance, in embodiments, the ladder 1000 may be adjusted into a stepladder or A-line position as shown in FIG. 31 or to a folded or leaning position. In other embodiments, other positions may be possible such as an extended straight position, an extended stepladder position, or an L or substantially L-shaped position of the ladder.

In the illustrated approach, the ladder 1000 includes front foot assemblies 1010 at the front ladder section 1002 and rear foot assemblies 1008 at the rear ladder section 1005. For instance, a first front foot assembly 1010a may be disposed at or adjacent a free or bottom end of the first front rail 1003a and a second front foot assembly 1010b may be disposed at or adjacent a free or bottom end of the second front rail 1003b, while a first rear foot assembly 1008a may be disposed at or adjacent a free or bottom end of the first rear rail 1006a and a second rear foot assembly 1008b may be disposed at or adjacent a free or bottom end of the second rear rail 1006b.

In some approaches, the foot assemblies 1010a, 1010b, 1008a, 1008b may all be the same. In some approaches, the front foot assemblies 1010 may be different from the rear foot assemblies 1008. For instance, the front foot assemblies 1010 and rear foot assemblies 1008 may include similar components having different dimensions. For instance, in one approach the front foot assemblies 1010 are proportionally larger or wider for fitting to larger front rails and/or for bearing weight of users climbing the front ladder section 1002. In some examples, the front foot assemblies 1010 and rear foot assemblies 1008 include different types or numbers of components and have different dimensions. For instance, in one illustrative configuration, the front foot assemblies 1010 include the configuration described below, having a footpad 1050 with a lip 1067, a foot cover 1075, and a rail insert, while the rear foot assemblies 1008 include a footpad (e.g., a smaller footpad) without a lip, the footpad attached to a rail insert without a foot cover, such as in the foot assemblies described in U.S. patent application Ser. No. 18/943,505 (attorney docket number 21601-160390), filed on Nov. 11, 2024, entitled “CURVED LADDER FOOTPAD AND LADDER FOOT ASSEMBLIES AND LADDERS THEREWITH”, the entire contents of which are incorporated herein by reference.

Further, while foot assembly 1010 is illustrated and described herein as a front foot assembly, it will be appreciated that the foot assembly 1010, foot cover 1075, and footpad 1050 included in the foot assembly 1010 can also be used as a rear foot assembly in certain approaches, or can be used with a ladder having only one set of feet.

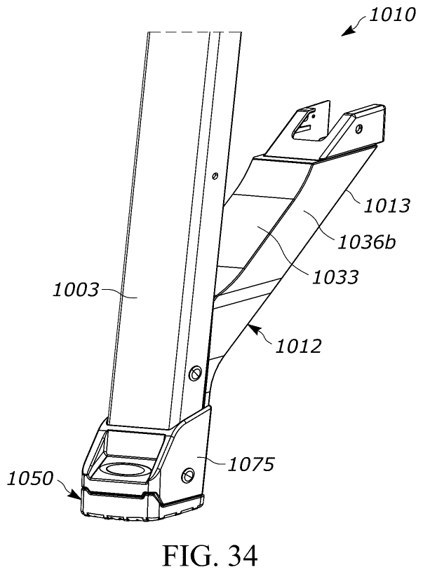

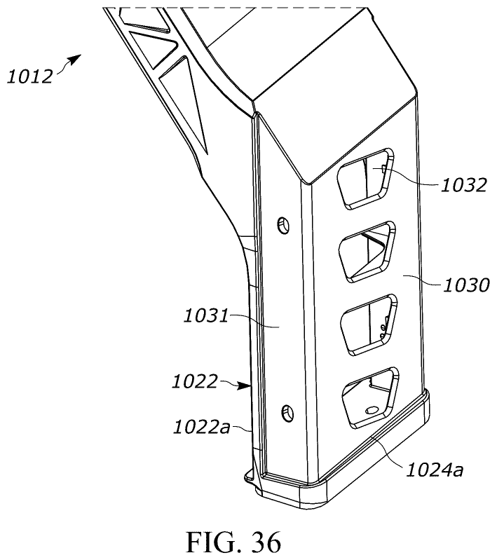

With reference to FIGS. 32-37, the front foot assembly 1010 may include an elongated foot component 1020 or rail insert and a footpad 1050 attached to the elongated foot component 1020. More specifically, the foot component 1020 may include a base 1024 defining a bottom of the foot component 1020 and a rail insert portion 1022 extending upward from the base 1024 and sized to be at least partially received within the front rail 1003. The footpad 1050 may be attached to a bottom side 1026 of the base 1024, as described further below.

In some approaches, the foot component 1020 is part of a brace 1012. The brace 1012 may be a “combination” brace, that is, a single piece that defines both the foot component 1020 and a brace component 1013. For instance, in some approaches the brace component 1013 extends from an end of the foot component 1020 at an angle with respect to the foot component 1020 and is sized and positioned to be coupled to a ladder rung, such as, for example, a bottom-most rung 1004a. Thus, the brace 1012 provides strengthening and support to the bottom rung 1004a and rail 1003 and also serves as a portion of the ladder foot. As illustrated, the angle defined between the foot component 1020 and the brace component 1013 of the brace 1012 may be greater than 90 degrees. For instance, in various approaches, the angle may be greater than 100 degrees, greater than 110 degrees, or greater than 120 degrees.

In an illustrative approach, the braces described herein are molded plastic components, for instance, formed from polypropylene or another polymer. In other approaches, the braces may be metal components, for instance formed from aluminum or steel.

In embodiments, the rail insert portion 1022 of the foot component 1020 includes a main web 1030, a first flange 1031 extending from and along one side of the web 1030, and a second flange 1032 extending from and along an opposite side of the web 1030, the first and second flanges 1031, 1032 spaced from and facing one another (e.g., substantially parallel to one another). In various approaches, the rail 1003 (or portions thereof) is a C-shaped rail having a main web 1035a, a first flange 1035b extending from and along one side of the web 1035a, and a second flange 1035c extending from and along an opposite side of the web 1035a, the first and second flanges 1035b, 1035c spaced from and facing one another (e.g., substantially parallel to one another). The main web 1035a, the first flange 1035b, and the second flange 1035c of the rail 1003 define a channel 1035 sized to receive at least a portion of the rail insert portion 1022 of the foot component 1020. For instance, in some configurations, the main web 1030 of the rail insert portion 1022 may be inserted within the channel 1035 and disposed proximate or in contact with the main web 1035a of the rail 1003 while the first and second flanges 1031, 1032 of the rail insert portion 1022 may be inserted within the channel 1035 and disposed proximate or in contact with the first and second flanges 1035b, 1035c of the rail 1003.

As shown, the base 1024 of the foot component 1020 may be wider than the channel 1035 of the rail 1003 so that the base 1024 is not inserted in the rail 1003. Instead, the widened base 1024 may define a ledge 1024a extending at a bottom of the web 1030, the first flange 1031, and the second flange 1032 of the rail insert portion 1022 which an end of the rail 1003 may be seated upon or positioned slightly above. In some approaches, the first and second flanges 1031, 1032 of the rail insert portion 1022 each define a step 1022a. The first and second flanges 1035b, 1035c of the rail 1003 may be sized to fit closely around the rail insert portion 1022 with terminal ends thereof either abutting or being slightly spaced from the step 1022a.

As illustrated, the first and second flanges 1031, 1032 of the rail insert portion 1022 and the first and second flanges 1035b, 1035c of the rail 1003 may each include one or more respective holes 1041, 1043 that align when the rail insert portion 1022 is properly inserted into the channel 1035 of the rail 1003. One or more corresponding fasteners 1042 (e.g., bolts, screws, or others) may extend through the holes 1041, 1043 to fix the rail insert portion 1022 to the rail 1003. For instance, the first and second flanges 1031, 1032 of the rail insert portion 1022 may each include two holes 1041 that align with two respective holes 1043 of each of the first and second flanges 1035b, 1035c of the rail 1003, with fasteners 1042 extending therethrough. Other amounts of holes and amounts of fasteners are possible. In some approaches, one or more of the holes 1041, 1043 may alternatively or additionally be disposed in the web 1030 of the rail insert portion 1022 and in the web 1035a of the rail 1003.

In some approaches, the foot cover 1075, described further below, includes one or more holes 1081 positioned to align with one or more holes 1041 of the rail insert portion 1022 and one or more holes 1043 of the rail 1003. Thus, the fasteners 1042 may extend through the respective holes 1041, 1043, and 1081 of the rail insert portion 1022, the rail 1003, and the foot cover 1075. For instance, in one approach, holes 1081a, 1081b in first and second flanges 1077, 1078 of the foot cover (FIG. 52) align with lowermost sets of holes 1041 in the flanges 1031, 1032 of the rail insert portion 1022 and lowermost sets of holes 1043 in the flanges 1035b, 1035c of the rail 1003 so that the three components can be fastened together with the rail 1003 sandwiched between the rail insert portion 1022 and the foot cover 1075.

In some approaches, the brace 1012 includes a top portion 1033 or top side extending over a top end of the rail insert portion 1022 and along the brace component 1013. The brace component 1013 may include, at least, the top portion 1033 and two side walls 1036a, 1036b extending downwardly from the top portion 1033. The side walls 1036a, 1036b may generally extend from the flanges 1031, 1032 of the rail insert portion 1022 and may extend at an angle therefrom. In some approaches, the flanges 1031, 1032 of the rail insert portion 1022 curve to form the side walls 1036a, 1036b of the brace component 1013. The brace component 1013 may further include fastening flanges 1037a, 1037b that extend, respectively, from the two side walls 1036a, 1036b. In some approaches, these flanges 1037a, 1037b are positioned to be attached to two downwardly extending flanges of the rung 1004a (not shown) and may include one or more holes for fastening to the rung 1004a. The shape, positioning, and number of flanges may be adjusted depending on the configuration of the rung 1004a.

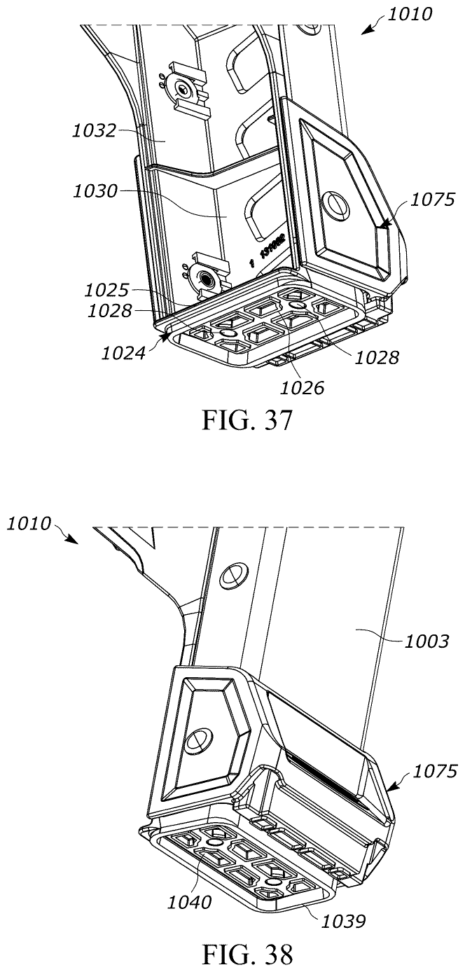

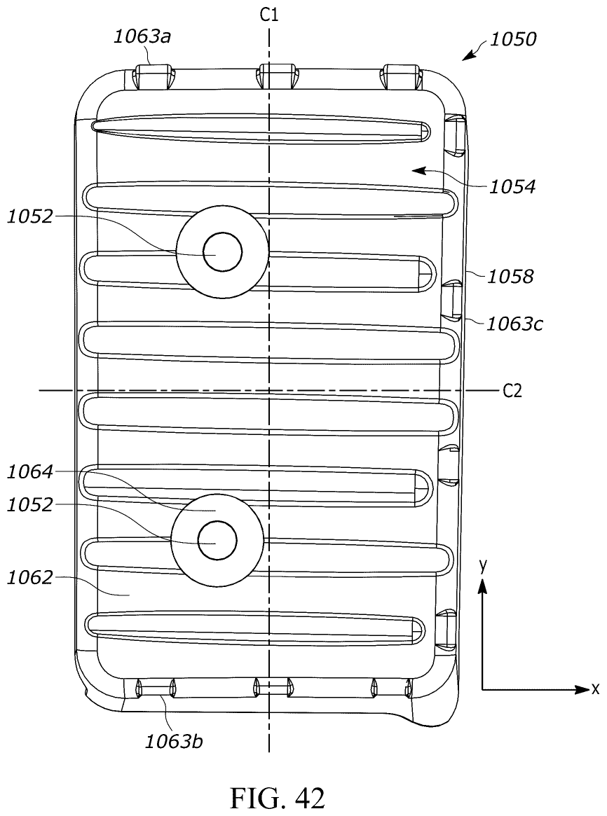

With reference to FIGS. 37-38 and 41-42, the base 1024 of the elongated foot component 1020 may have a slim, generally flat profile, and is coupled to the footpad 1050. In some approaches, the shape of the base 1024 is selected to generally correspond to the shape of the rail 1003 for a compact combination of the components. For instance, in the illustrated embodiment, the base 1024 is generally rectangular, having a length only slightly longer than a corresponding length of the rail 1003 and a width only slightly wider than a corresponding width of the rail 1003. Other shapes of the rail 1003 and base 1024 are possible.

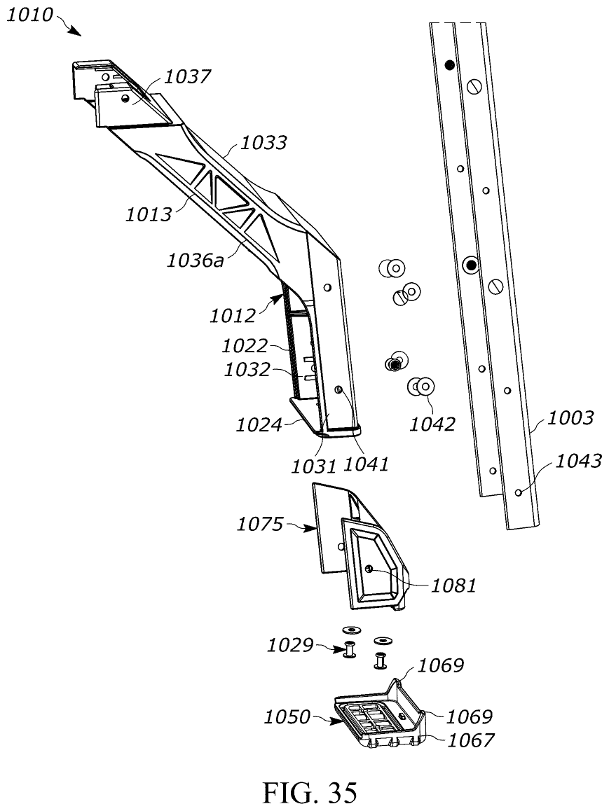

In some embodiments, one or more holes 1028 extend through the base 1024 from a top side 1025 of the base 1024 to a bottom side 1026 of the base 1024. For instance, there may be two holes 1028 spaced along a longitudinal centerline of the base 1024. Fasteners 1029 (FIG. 35) may extend through the holes 1028 and corresponding holes 1052 of the footpad 1050 to couple the footpad 1050 to the base 1024. The number and position of the holes and fasteners is not particularly limited. In other approaches, other forms of coupling are possible, such as gluing, welding, or co-molding the base 1024 and pad 1050.

In some embodiments, the base 1024 and the footpad 1050 may have interlocking features which help to maintain contact between the engaging surfaces of the base 1024 and footpad 1050 and to maintain proper alignment or positioning of the footpad 1050 with respect to the base 1024. For instance, the bottom 1026 of the base 1024 may include one or more projections, recesses, or other interlocking elements 1040 that interlock with one or more complementary projections, recesses, or other interlocking elements 1060 disposed at a top side 1053 of the footpad 1050. For example, as shown, the base 1024 defines a downwardly extending peripheral flange 1039 that may engage or interlock with a complementary recessed portion or groove 1059 at the top 1053 of the footpad 1050. In addition, the base 1024 includes an arrangement of ribs and coring/negative space that interlocks with complementary coring/negative space and ribs of the footpad 1050. For instance, in the illustrated approach, the base 1024 includes two columns of ribs arranged on either side of the holes 1028 that engage complementary recessed portions of the footpad 1050. Other arrangements are possible.

In embodiments, the footpads disclosed herein may be formed from a plastic, rubber, or other suitable material that exhibits some flexibility, compressibility, and/or softness. In an exemplary, non-limiting approach, the footpads may be formed from a flexible polyvinyl chloride material. Other elastomeric materials can be used, for example, those that exhibit a low modulus of elasticity and/or up to one thousand percent of elastic deformation.

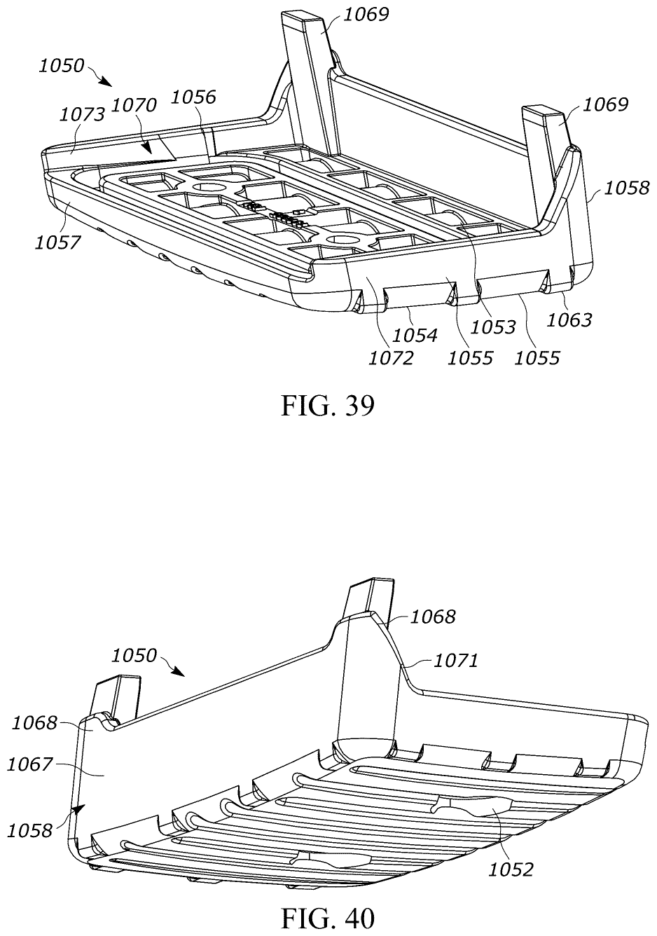

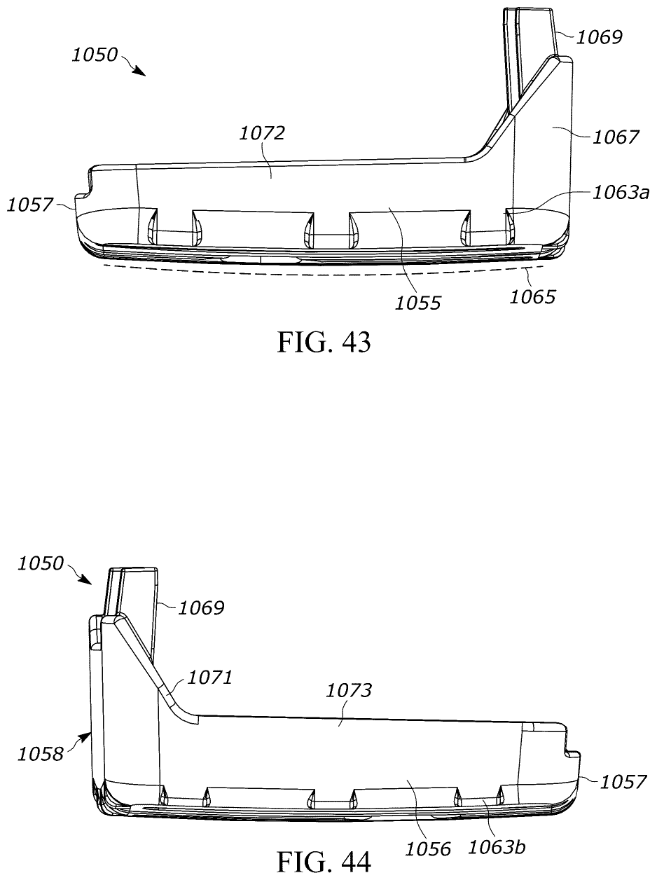

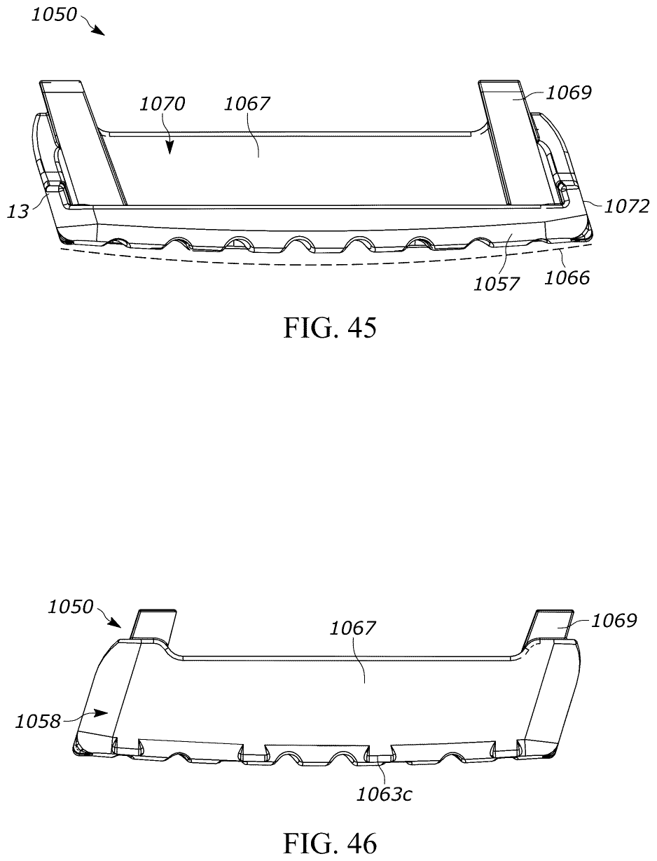

With reference to FIGS. 39-46, the footpad 1050 may have a generally rectangular shape, though other shapes are possible, such as, e.g., a trapezoidal shape. The footpad 1050 defines a top side or face 1053, a bottom side or face 1054 opposite the top side 1053, and four lateral sides or faces extending at least in part between the top side 1053 and the bottom side 1054, such as a first side 1055, a second side 1056, a third side 1057, and a fourth side 1058. When positioned on the foot assembly 1010 and ladder, in some approaches the first side 1055 may be a front side, the second side 1056 may be a rear side, the third side 1057 may be an inner side, and the fourth side 1058 may be an outer side. As noted above, holes 1052 may extend through the footpad 1050 from the top side 1053 to the bottom side 1054 for receiving fasteners. The holes 1052 may be sunken in or recessed with respect to the bottom side 1054. For instance, the bottom side 1054 may include a central recess 1064, and the hole 1052 may extend from the bottom of the recess 1064 to the top side 1053. The recess 1064 provides extra space at the bottom side 1054 of the footpad 1050 for a head of a fastener so that the fastener does not come in contact with the ground.

The footpad 1050 includes treading or treads 1062 to provide grip, traction, or resistance to movement during use of the ladder. In an illustrative approach, the treads 1062 are formed integrally with the footpad 1050 and may be disposed on the bottom 1054 of the footpad 1050. For example, as shown, the treads 1062 at the bottom 1054 of the footpad 1050 may be elongated treads (e.g., alternating treads and grooves), each tread extending from the third or inner side 1057 to the fourth or outer side 1058. The treads may also be present in other patterns. In an illustrative embodiment, the treading extends all the way to the sides 1057, 1058 of the footpad 1050 such that the sides 1057, 1058 partially define the outermost treads.

In an illustrative embodiment, the footpad 1050 also includes side treading 1063 extending at least partially along one or more of the sides 1055, 1056, 1057, 1058 of the footpad 1050. For instance, as illustrated, the side treads 1063 may be present at a lower rounded edge between the sides 1055, 1056, 1058 and the bottom 1054, and may extend in part up the sides 1055, 1056, 1058. More specifically, first side treads 1063a may be disposed on side 1055, second side treads 1063b may be disposed on side 1056, and third side treads 1063c may be disposed on side 1058. In some embodiments, side treads are present on all four lateral sides 1055, 1056, 1057, 1058. In some approaches, the first side treads 1063a on the first or front side 1055 may be larger than the other side treads 1063b, 1063c, for example extending higher up the side. As illustrated, the side treads 1063 may be arcuate projections, though other configurations are possible. In some embodiments, there may be at least 2, or at least 3 side treads on each of sides 1055, 1056, and 1058.

In some embodiments, the treading may be configured to provide grip, traction, or resistance to movement in two different directions. For example, as shown, the treads 1062 at the bottom 1054 of the footpad 1050 extend between the inner side 1057 and the outer side 1058, resisting movement in a first direction, such as the y direction. The first and second side treads 1063a, 1063b disposed on sides 1055 and 1056, however, may include a plurality of treads spaced in the x direction, resisting movement of the foot and ladder in a second direction, such as the x direction. Thus, the treads may resist movement in both the x direction and the y direction to prevent the ladder from slipping in the x and y direction during use. In some embodiments, the third side treads 1063c disposed on side 1058 also resist movement in the y direction. As shown, the third side treads 1063c may be at least partially offset from the treads 1062 at the bottom 1054. The treads may also be present in other configurations and patterns.

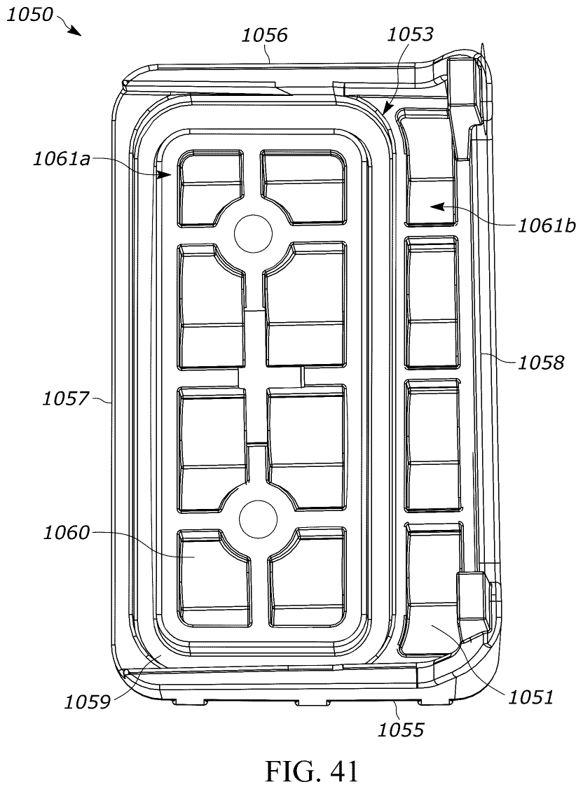

As noted above, the footpad 1050 may be enlarged or widened relative to the rail 1003 and relative to the base 1024 of the foot component 1020, and thus provides an enlarged or widened footprint or area of engagement with the ground for increased stability of the ladder. For instance, in some approaches, the footpad 1050 includes a base portion 1061a and an extended or widened portion 1061b. The base portion 1061a is about the same size as the base 1024 of the foot component 1020 and the rail 1003, such that the base portion 1061a can be aligned with the base 1024 and rail 1003 and coupled thereto. For instance, as shown in FIG. 41, the base portion 1061 may include interlocking features 1060 for interlocking with complementary interlocking features 1040 of the base 1024 of the foot component 1020, such as a groove 1059 sized to receive the peripheral downturned flange 1039 of the base 1024, as well as additional recesses and/or ribs inward of the groove 1059 for interlocking with other complementary interlocking features of the base 1024. In addition, the holes 1052 for fastening the footpad 1050 to the base 1024 are positioned within the base portion 1061a, for instance along a longitudinal centerline of the base portion 1061a (and offset from a longitudinal centerline of the entire footpad 1050).

The extended portion 1061b is sized to extend or widen the footpad 1050 relative to a corresponding width of the base 1024 of the foot component 1020 and rail 1003. Thus, the extended portion 1061b of the footpad 1050 extends beyond the base 1024 of the foot component 1020 and rail 1003 when the components are assembled, increasing the footprint of the foot assembly and thereby providing extra grip and stability. In some approaches, the extended portion 1061b is an extension of the footpad 1050 between the base portion 1061a and the fourth side 1058 of the footpad 1050. More specifically, when the fourth side 1058 is an outer side of the footpad 1050 and positioned on an outer side of the foot assembly 1010 and ladder (e.g., as shown in FIG. 33), the ladder foot is widened outwardly and provides increased lateral grip and stability.

In some approaches, the extended portion 1061b widens the footpad 1050 relative to the base 1024 of the foot component and rail 1003 by at least 10%, at least 20%, at least 25%, at least 30%, at least 35%, or at least 40%. In some approaches, the increase may be between about 10% and about 70%. In exemplary embodiments, the increase in width is between about 25% and about 70% or between about 30% and about 50%. In some approaches, the increase may be up to 100%, up to 200%, or up to 300%. For instance, the extended portion 1061b may widen the footpad 1050 by up to three times the width of the base 1024 of the foot component.

To support the increased width of the footpad 1050, distribute weight between the ladder and the entire footpad 1050 during use of the ladder, and to improve gripping, the footpad 1050 includes an upstanding wall or lip 1067 that interlocks or engages with a foot cover 1075 (see, e.g., FIG. 48). In some approaches, the lip 1067 is an extension of the fourth or outer side 1058 of the footpad 1050, though in other approaches the lip 1067 may extend from one of the other sides 1055, 1056, 1057. More specifically, the outer side 1058 and lip 1067 together have a height that extends above the top side 1053 of the footpad 1050. In some configurations, the lip 1067 extends an entire length of the fourth or outer side 1058 of the footpad 1050. As illustrated, the lip 1067 may also wrap around the corners between the side 1058 and adjacent sides 1055, 1056 and extend partially along the adjacent sides 1055, 1056. For instance, as illustrated, the lip 1067 may include angled side portions 1071 that angle downwardly along proximate portions of the adjacent sides 1055, 1056.

Advantageously, the lip 1067 provides extra grip surface area along the side 1058 of the footpad 1050. This can be particularly useful in a compact ladder that is being used in a tight space, since the lip 1067 provides traction against corners, walls, or other objects.

The lip may be generally flat and smooth and may extend upwardly from the bottom 1054 at about a 90 degree angle. In other configurations, the lip may extend at different angles, such as between 80 degrees and 115 degrees. In some approaches, the lip is sized, shaped, and positioned to be received within a lip-receiving portion 1086 or cutout of the foot cover 1075, as shown in FIG. 48. For instance, the lip 1067 may have a height generally corresponding to a height of the lip-receiving portion 1086 of the foot cover. In some approaches, the lip 1067 may have a generally linear top and a flat interior surface that contacts, engages, abuts, and/or interlocks with complementary portions of the lip-receiving portion 1086 of the foot cover 1075. In some embodiments, the lip 1067 may include one or more protrusions 1068 extending upwardly at the ends of the lip 1067 on the fourth side 1058, which may have a geometry complementary to corresponding cut-outs 1083a, 1083b in the lip-receiving portion 1086 of the foot cover 1075 (described further below). As shown, there may be two respective protrusions 1068, each extending extending upwardly at each end of the lip 1067. The two protrusions 1068 may be continuous with and partially define the angled side portions 1071 that extend along adjacent portions of the sides 1055, 1056.

In some approaches, the footpad 1050 includes one or more narrow posts 1069 or nibs that extend upwardly from the lip 1067. For instance, as illustrated, there may be two posts 1069 positioned at each end of the lip 1067. The posts 1069 may be sized and positioned to be received within corresponding pockets 1083a, 1083b of the foot cover 1075 (FIG. 52). The posts 1069 aid in assembly by facilitating alignment of the footpad 1050 with the foot cover 1075 and also maintain the lip 1067 in position against the foot cover 1075. The posts 1069 also help to prevent the lip 1067 and footpad 1050 from peeling outward over time, since the posts 1069 hold the lip 1067 inwards against the foot cover 1075. In addition, transport and storage of the ladder can cause the material of the lip 1067 to catch on other materials or objects which can deform the lip 1067 and the footpad 1050. The posts 1069 prevent this issue by maintaining the lip 1067 closely secured against the foot cover 1075 so that it cannot be pulled or stretched during transport and storage. While two posts 1069 are illustrated, the number of posts, as well the size, shape, and positioning of the posts is not particularly limited. As illustrated, the two protrusions 1068 of the lip 1067 may be positioned to provide extra support for the posts 1069.

In various approaches, the posts 1069 may extend above the lip 1067 about 0.15 inches to about 0.4 inches. In illustrative embodiments, the posts 1069 may extend about the lip 1067 about 0.215 inches. In some approaches, the posts 1069 are formed integrally with the footpad 1050 (and made of the same material). In some approaches, the posts 1069 may be comprised of an elastomeric material or a metallic or nonmetallic rigid or semi-rigid material that may be inserted/affixed to the pad as part of a separate manufacturing or assembly step.

The footpad 1050 may also include one or more upstanding walls extending from the other sides 1055, 1056, 1057 in addition to the lip 1067. For example, as shown, the sides 1055, 1056 that are adjacent to the lip 1067 may each define an upstanding side wall 1072, 1073, respectively, that extends above the top 1053 of the footpad 1050. In some approaches, heights of the upstanding side walls 1072, 1073 are lower than the height of the lip 1067. The lip 1067 and the upstanding side walls 1072, 1073 may together partially define a cavity 1070 at the top side 1053 of the footpad 1050 for receiving the base 1024 of the foot component 1020 and a portion of the foot cover 1075. Like the lip 1067, the upstanding side walls 1072, 1073 provide side gripping when against corners, walls, or other objects.

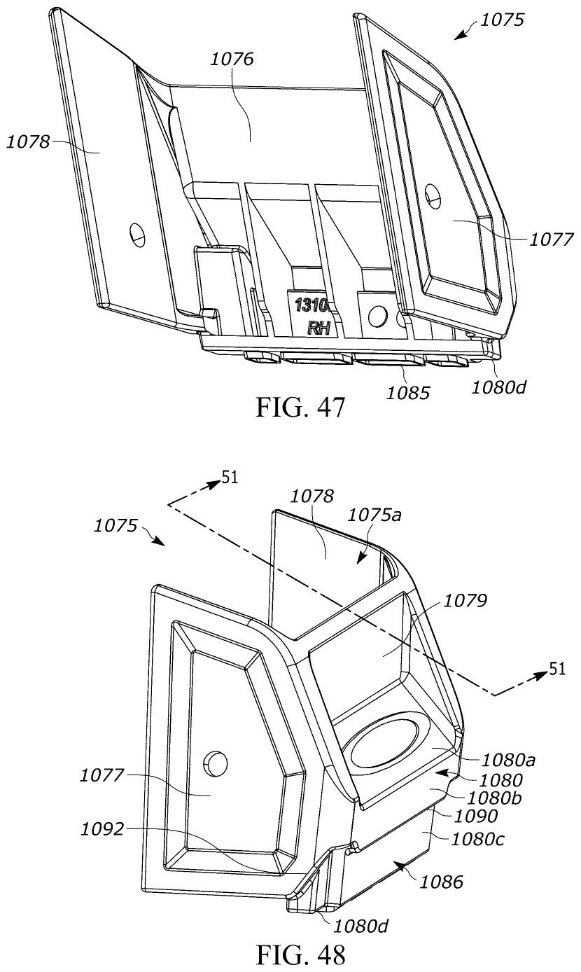

The extended portion 1061b of the footpad 1050 further may include one or more interlocking elements such as ribs or recesses disposed at the top side 1053 of the footpad 1050 for interlocking with complementary interlocking elements 1085 of the foot cover 1075 (FIG. 47), described further below. For instance, as shown, there may be a single row of generally rectangular recesses sized to interlock with complementary ribs 1085 on a bottom portion 1080d of the foot cover 1075 (FIG. 47).

The footpad 1050 may also have a curved bottom side 1054. For instance, the bottom side 1054 may have at least one curvature extending substantially from one side of the footpad 1050 to the opposite side of the footpad 1050. For instance, the bottom side 1054 may define a curvature from the first or front side 1055 to the second or rear side 1056 and/or a curvature from the third or inner side 1057 to the fourth or outer side 1058. In illustrative approaches, the bottom side 1054 defines two different curvatures. For instance, as shown, the bottom side 1054 may define a first curvature 1065 extending from the first or front side 1055 to the second or rear side 1056, and a second curvature 1066 extending from the third or inner side 1057 to the fourth or outer side 1058.

In some approaches, the first and second curvatures 1065, 1066 may have the same curvature. In other approaches, the first and second curvatures 1065, 1066 may be different. In the illustrated approach, for example, the first curvature 1065 and the second curvature 1066 are generally symmetrical about centerlines C1 and C2, respectively, though may have different radii of curvature. For instance, the first curvature 1065 may generally curve downward from the inner side 1057 to the centerline C1 and then back upward from the centerline C1 to the outer side 1058, defining a partial spherical profile. Thus, the footpad 1050 may progressively thicken from the inner side 1057 to the centerline C1 and from the outer side 1058 to the centerline C1. The second curvature 1066 may be similarly configured, curving downward from the front side 1055 to the centerline C2 and then back upward from the centerline C2 to the rear side 1056.

In other embodiments, the first curvature 1065 and/or the second curvature 1066 may have a more conical, asymmetrical profile, with a gradual tapering from one side to the other. For instance, the inner side 1057 of the footpad 1050 may be thinner than the outer side 1058 due to the first curvature 1065. In some approaches, instead of one or both of the curvatures, the bottom 1054 may define one or more angled tapers of the footpad 1050. In some embodiments, the bottom contour may define an angled segment that gradually curves.

The exact radii of curvature of the first and second curvatures 1065, 1066 may depend, in different approaches, on the dimensions of the footpad 1050 (e.g., the lengths of the sides 1055, 1056, 1057, 1058). However, in illustrative approaches, the length of the sides 1055, 1056 is about 2 to 3 inches (e.g., about 2.20 inches) and the length of the sides 1057, 1058 is about 3.2 to 4.5 inches (e.g., about 3.52 inches), the radius of curvature of the first curvature 1065 is about 10 inches to about 25 inches (e.g., about 16.5 inches), and the radius of curvature of the second curvature is about 10 inches to about 30 inches (e.g., about 21 inches).

Advantageously, the multiple curvatures of the footpads described herein mitigate stability issues that commonly occur with ladders. For instance, even when ladders are used on a relatively flat ground, ladders tend to exhibit wobbliness. A footpad with multiple slight curvatures, however, permits the footpad to adapt precisely to the specific points of an uneven surface, reducing wobble and rendering the ladder more stable during use.

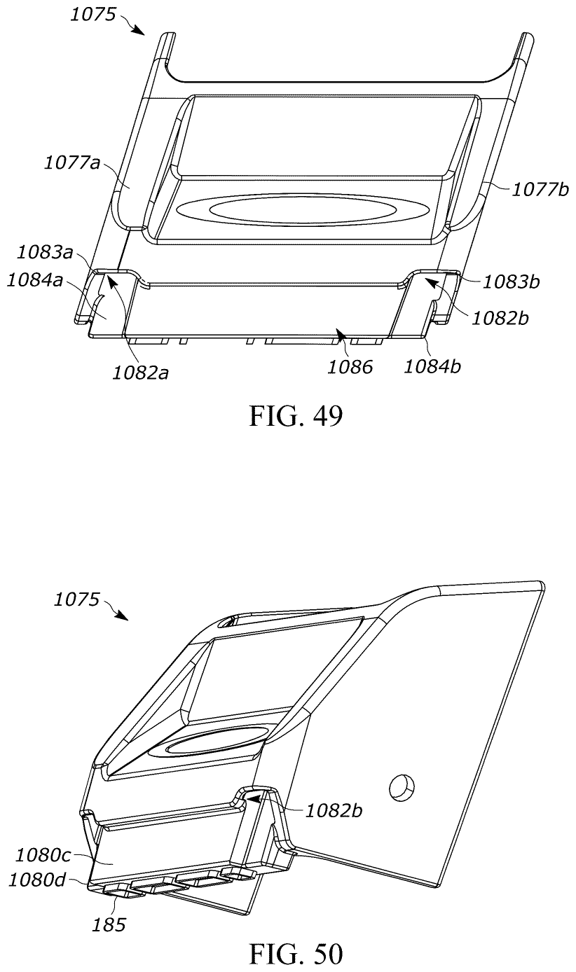

With reference to FIGS. 47-52, the foot cover 1075 may be sized and shaped to at least partially extend around a bottom of the rail 1003 and the foot component 1020. More specifically, the foot cover 1075 includes a main web portion 1076, a first side flange 1077, and a second side flange 1078, the first side flange 1077 and the second side flange 1078 extending from opposite ends of the main web portion 1076 and facing one another, defining a generally C-shaped channel 1075a therebetween. When assembled with the foot component 1020 and the rail 1003, the main web portion 1076 of the foot cover 1075 aligns with and covers the web portion 1035a of the rail 1003 while the side flanges 1077, 1078 align with and cover the flanges 1035b, 1035c of the rail 1003, respectively. As noted above, in some approaches the side flanges 1077, 1078 include one or more holes 1081, such as holes 1081a, 1081b, positioned to align with respective holes 1041, 1043 in the foot component 1020 and the rail 1003 to secure the foot cover 1075, the rail 1003, and the foot component 1020 together (FIG. 35).

The web portion 1076 of the foot cover 1075, in some approaches, includes an upper wall portion 1027 with a flat geometry that generally corresponds or conforms to the rail 1003. In various approaches, the upper wall portion 1027 engages the rail 1003 or may be slightly spaced from the rail 1003 when the rail 1003 is received within the channel 1075a of the foot cover 1075. The web portion 1076 further defines a lower extended wall portion 1080. The lower extended wall portion 1080 of the foot cover 1075 extends outwardly from the upper wall portion 1027 and outwardly from the rail 1003. Thus, the lower, extended wall portion 1080 extends or widens the ladder footprint beyond the rail 1003 and the foot component 1020, providing support, connection, and transfer of force/load to the extended portion 1061b of the footpad 1050 and the lip 1067.

More specifically, the lower, extended wall portion 1080 defines a first angled wall segment 1080a which extends downwardly and outwardly at an angle below the upper wall portion 1027. The lateral extent of the first angled wall segment 1080a is selected to correspond to the width of the extended portion 1061b of the footpad 1050. The lower extended wall portion 1080 may also include a second wall segment 1080b that extends downwardly from the first angled wall segment. The second wall segment 1080b may also define a lower surface 1090 that may be engaged by a top of the lip 1067 when the lip 1067 interlocks with the foot cover 1075. The lower, extended wall portion 1080 may further define a third wall segment 1080c below the second wall segment 1080b and lower surface 1090 that is recessed or positioned inwardly with respect to the second wall segment 1080b and lower surface 1090. Together, the second wall segment 1080b, lower surface 1090, and third wall segment 1080c define the lip-receiving portion 1086 or cutout of the foot cover 1075. Specifically, an interior surface or interior side of the lip 1067 is sized and positioned to engage or wrap against an exterior surface of the third wall segment 1080c, with a top of the lip 1067 engaging or close to the lower surface 1090 of the second wall segment 1080b. When assembled with the lip 1067 received in the lip-receiving portion 1086, the exterior surface of the lip 1067 may be substantially flush with the second wall segment 1080b. While the shape of the lip 1067 may vary in different approaches, the shape of the lip-receiving portion 1086 should generally correspond to a shape of the lip 1067 so that the lip 1067 is securely and compactly received within the lip-receiving portion 1086.

The lower extended wall portion 1080 may also include a bottom surface 1080d below the third wall segment 1080c and extending inwardly toward the rail 1003. The bottom surface 1080d may include a plurality of interlocking elements 1085, such as grooves or ribs, that interlock with the footpad 1050 at the extended portion 1061b of the footpad 1050. For instance, as noted above, the bottom surface 1080d may include a plurality of ribs that interlock with complementary recesses 1051 in the extended portion 1061b of the footpad 1050 to help maintain the connection between the footpad 1050 and the foot cover 1075.

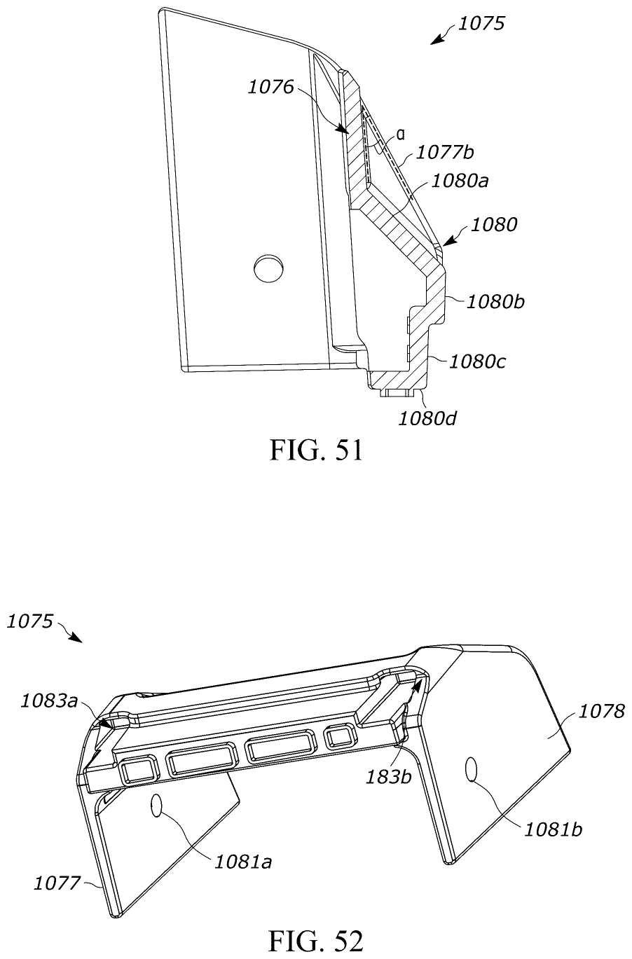

The foot cover 1075 may also include angled supports 1077a, 1077b defined between the web portion 1076 and the first and second side flanges 1077, 1078. The angled supports 1077a, 1077b may extend outwardly at an angle from a top of the upper wall portion 1079 to a top of the second wall segment 1080b. The angled supports 1077a, 1077b help to distribute weight and transfer forces from the rail 1003 to the extended portion 1061b of the footpad 1050 during use of the ladder. In some approaches, an angle α, shown in FIG. 51, defined between the web portion 1076 and the angled supports 1077a, 1077b (or between the web portion 1035a of the rail 1003 and the angled supports 1077a, 1077b) is 80 degrees or less, 70 degrees or less, 60 degrees or less, 50 degrees or less, 45 degrees or less, or 40 degrees or less. In some embodiments, a minimum for the angle is at least 20 degrees.

As discussed above, the foot cover 1075 also may include one or more pockets or holes, such as pockets 1082a, 1082b, which are shaped and positioned to receive and retain the posts 1069 projecting upwardly from the lip 1067. The pockets 1082a, 1082b, for instance, may be positioned at opposite ends of the web portion 1076 of the foot cover 1075, at the corners or transitions between the web portion 1076 and the side flanges 1077, 1078. In one approach, the pockets 1082a, 1082b are defined in part by cored-out portions of the second wall segment 1080b. The pockets 1082, 1082b may extend upwards towards or into the angled supports 1077a, 1077b. In some approaches, the second wall segment 1080b also defines recesses 1083a, 1083b or grooves shaped to receive the protrusions 1068 of the lip 1067.

In some approaches, the lip-receiving portion 1086 also includes lower cut-outs 1084a, 1084b positioned and shaped to receive lower portions of the posts 1069 which do not extend above the top of the lip 1067. The lower cut-outs 1084a, 1084b may be cut-outs in the third wall segment 1080c and positioned just below the pockets 1082a, 1082b. Other geometries of the lip-receiving portion 1086 of the foot cover 1075 and the lip 1067 are possible.

As illustrated, the side flanges 1077, 1078 of the foot cover 1075 may be generally flat to closely surround the rail 1003, and may define a generally polygonal shape that shares an angle with the angled supports 1077a, 1077b. In some embodiments, the polygonal shape of the side flanges 1077, 1078 may also define angled sides 1092 corresponding to and positioned to receive or engage the angled side portions 1071 of the lip 1067. In some configurations, the shape of the side flanges 1077, 1078 may include rounded corners or curvatures instead of or in addition to distinct angles and sides.

In an illustrative approach, the foot covers described herein are molded plastic components, for instance, formed from polypropylene or another polymer.

With reference to FIGS. 35, 38, 39, 41, 47, 48, and 49, in some aspects, a method of assembling a foot ladder assembly such as the foot ladder assembly 1010 includes the steps of positioning the foot component 1020 at a bottom end of a rail 1003, with a rail insert portion 1022 of the foot component 1020 inserted within the channel of the rail 1003; inserting the bottom end of the rail 1003 into the channel 1075a of the foot cover 1075 so that corresponding holes in the rail insert portion 1022, rail 1003, and foot cover 1075 align; extending fasteners through the holes of the rail insert portion 1022, rail 1003, and foot cover 1075 to fix the components together; coupling the footpad 1050 to a base 1024 of the foot component 1020 by extending a fastener through respective holes in the base 1024 and the footpad 1050; and positioning the lip 1067 of the footpad 1050 to engage the lip-receiving portion 1086 of the foot cover 1075. In some approaches, the method includes inserting the posts 1069 extending from the lip 1067 into the pockets 1082a, 1082b of the foot cover 1075 and engaging interlocking elements 1085 of the foot cover 1075 with complementary interlocking elements 1051 of the footpad 1050. The method may further include engaging interlocking elements 1040 of the base 1024 of the foot component 1020 with complementary interlocking elements 1060 of the footpad.

As noted above, the ladder foot assemblies described herein advantageously widen the base of a ladder, increasing contact of the ladder with the ground while being relatively compact and lightweight. The ladder foot assemblies have improved gripping and weight distribution of a load, providing stability to the ladder during use. In addition, being relatively compact, the ladder foot assemblies do not significantly alter the ladder's storage or transport dimensions.

The ladders, components, and/or accessories described herein may be formed of a variety of materials and using a variety of manufacturing techniques. Such materials may include, e.g., metals, plastics and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as aluminum or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of meatal materials such as magnesium, magnesium alloys, aluminum, or aluminum alloys. The rungs may be manufactured, for example, via an extrusion process and cut to length. The rungs may take a variety of shapes and may be, for example, rounded, D-shaped, or triangular. Further, the rungs may have a hollow or substantially hollow cross-section.

The rungs of a ladder may be attached to the rails in a variety of different manners. In one approach, the rungs and rails are forged together, such as by having the rungs being attached to the rails via a direct swage connection. In a direct swage connection, a rung is attached directly to the rails using a cold forming process, where a moving die shapes the rung around a hole that was pre-punched in the rail. Annealing operations may be used to soften the metal to prevent cracking. In other approaches, the rungs are attached to the rails via a rung-plate connection in addition to other attachment types. In a rung-plate connection, a rung is attached to a plate and the plate is attached to the rail via one or more rivets or other mechanical elements.

Other accessories and assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee caps may be riveted to the ladder.

It will be understood that various changes in the details, materials, and arrangements of parts and components which have been described and illustrated above to explain the nature of the anchor device may be made by those skilled in the art within the principle and scope of the anchor device as expressed in the following claims. Furthermore, while various features have been described regarding a particular embodiment or a particular approach, the foregoing description and accompanying drawings is offered by way of illustration only and not as a limitation. Further, while embodiments have been shown and described, it will be apparent to those skilled in the art that modifications may be made to them without departing from the broader aspects of the technological contribution. The actual scope of the protection sought is defined in the following claims.

What is claimed is:

1. A ladder comprising:
at least one ladder section comprising a first rail and a second rail and at least one rung connecting the first rail and the second rail; and
a ladder foot at a bottom end of the first rail the ladder foot comprising:
an elongated foot component and a footpad,
the foot component comprising a base defining a bottom side of the foot component and a rail insert portion extending from the base and received at least partially within the first rail,
the footpad attached to the base at the bottom side, the footpad comprising a curved bottom having at least two curvatures.

2. The ladder of claim 1, the footpad including four sides extending from the curved bottom, the four sides including an inner side, an outer side, a front side, and a rear side, wherein the bottom defines a first curvature from the inner side to the outer side and a second curvature from the front side to the rear side.

3. The footpad of claim 2, wherein the first curvature defines a tapering of the footpad from the outer side to the inner side.

4. The ladder of claim 1, wherein the foot component is part of a brace, the brace including the foot component and a brace component extending from the foot component at an angle with respect to the foot component, the brace component sized and positioned to be coupled to a bottom rung of the at least one rung.

5. The ladder of claim 1, wherein the bottom side of the foot component includes one or more projections or grooves that interlock with one or more corresponding grooves or projections defined in a top side of the footpad.

6. A footpad for a ladder, comprising:
a top side and a bottom side, the bottom side defining treading; and
a front side, a rear side, an inner side, and an outer side,
wherein the bottom side is curved, defining a first curvature from the inner side to the outer side and a second curvature from the front side to the rear side.

7. The footpad of claim 6, wherein the first curvature is substantially symmetrical about a first centerline of the bottom side and/or the second curvature is substantially symmetrical about a second centerline of the bottom side.

8. The footpad of claim 6, wherein the first curvature defines a tapering of the footpad from the outer side to the inner side.

9. The footpad of claim 8, wherein the second curvature defines an increasing thickness of the footpad from the front side to a centerline of the bottom and from the rear side to the centerline.

10. The footpad of claim 6, wherein the front side, the rear side, the inner side, and the outer side define at least a portion of the treading.

11. The footpad of claim 6, wherein the treading is present in two different directions to provide grip in two different directions.

12. A ladder comprising:
at least one ladder section comprising a first rail and a second rail and at least one rung connecting the first rail and the second rail; and
a ladder foot at a bottom end of the first rail, the ladder foot comprising:
a rail insert inserted at least in part within the first rail;
a cover extending at least in part about the first rail; and
a footpad attached adjacent an end of the rail insert, the footpad comprising a lip extending upwardly and engaging the cover.

13. The ladder of claim 12, wherein an exterior side of the cover comprises a cutout shaped to receive a portion of the lip.

14. The ladder of claim 12, wherein the footpad is wider than a base of the rail insert and the ladder rail, and the cover comprises a lower portion that extends outwardly from the rail and engages a portion of the footpad that extends beyond the base.

15. The ladder of claim 12, wherein the footpad includes one or more posts extending upwardly from the lip that are received within one or more corresponding holes defined in the cover to maintain the lip in position.

16. The ladder of claim 12, wherein the footpad includes a top side, a bottom side with treading, and four lateral sides, wherein the lip is formed from an upward extension of one of the lateral sides.

17. The ladder of claim 16, wherein the top side includes at least one groove or projection that interlocks with a complementary groove or projection of the cover.

18. The ladder of claim 12, wherein the cover comprises a web portion, a first flange extending from one end of the web portion, and a second flange extending from an opposite end of the web portion, the first flange generally facing the second flange and defining a channel therebetween for receiving the ladder rail.

19. The ladder of claim 18, wherein the web portion of the cover includes an upper wall portion positioned generally proximate the ladder rail and a lower wall portion that extends outwardly relative to the ladder rail to engage a portion of the footpad that extends past a base of the rail insert.

20. The ladder of claim 12, wherein the rail insert is part of a brace, the brace including the rail insert and a brace component extending from the rail insert at an angle with respect to the rail insert, the brace component coupled to a bottom rung of the at least one rung.
